(19) United States
(12) Patent Application Publication
(10) Pub. No.: US 2025/0304772 A1
(43) Pub. Date: Oct. 2, 2025

(54) Flame Retardant Polymer Composition with Increased Thermal Shock Resistance

(71) Applicant: Celanese Polymers Holding, Inc., Wilmington, DE (US)

(72) Inventors: Huan Zhang, Shanghai (CN); Ling Hong Wu, Shanghai (CN); Juergen Schmidt, Utzenfeld (DE); Stephan Eilbracht, Prevessin-Moens (FR); Wanli Wang, SHANGHAI (CN)

(21) Appl. No.: 19/093,843

(22) Filed: Mar. 28, 2025

Related U.S. Application Data
(60) Provisional application No. 63/661,220, filed on Jun. 18, 2024.

(30) Foreign Application Priority Data
Apr. 1, 2024 (WO) PCT/CN2024/085188

(51) Int. Cl. C08K 13/04; C08K 3/38; C08K 5/1539; C08K 5/52; C08K 5/5313; C08K 7/14; C08L 77/06

(52) U.S. Cl. CPC C08K 13/04; C08L 77/06; C08K 2003/387; C08K 5/1539; C08K 5/5205; C08K 5/5313; C08K 7/14; C08K 2201/014; C08L 2201/02; C08L 2203/20; C08L 2205/025; C08L 2205/03; C08L 2312/00

(57) ABSTRACT

A polymer composition is disclosed, particularly a polyamide composition, that has excellent flame resistance and thermal shock resistance. The composition also has excellent electrical insulation properties. The composition contains at least one polyamide polymer, optionally glass fibers, and a crosslinked thermoplastic vulcanizate.

### RELATED APPLICATIONS

The present application is based upon and claims priority to International Patent Application No. PCT/CN2024/085188, having a filing date of Apr. 1, 2024, and U.S. Provisional Patent Application Ser. No. 63/661,220, having a filing date of Jun. 18, 2024, both of which are incorporated herein by reference in their entirety.

### BACKGROUND

Electric vehicles, such as battery-powered vehicles, plug-in hybrid-electric vehicles, mild hybrid-electric vehicles, or full hybrid-electric vehicles generally have an electric powertrain that contains an electric propulsion source (e.g., battery) and a transmission. Plastic materials are often employed in the electric vehicle for various electronic components, such as high voltage connectors, power converter housings, busbars, inverters, converters, onboard charger bases, relay box frames, busbars, grommet moldings, and the like.

In many instances, the plastic material or polymer composition is used to form a metal overmolded part in which the polymer composition acts as an insulator to a metal component that is electrically connected within the vehicle. The polymer compositions are typically required to have flame resistant properties. When flame retardants, however, are incorporated into the polymer compositions, various properties of the composition may be degraded. Even when containing flame retardants, insulating polymers in metal overmolded parts should display good thermal shock resistance, which means that the polymer article should show no cracks and should be able to maintain good insulting properties after many thermal cycles. In addition to good thermal shock resistance, the polymer composition should also maintain a relatively high comparative tracking index over time even as the voltages increase and the size of the parts decrease.

In view of the above, a need exists for a polymer composition well suited for use in metal overmolded applications that has good flame resistance while also having good thermal shock resistance in addition to displaying a relatively high comparative tracking index.

### SUMMARY

In general, the present disclosure is directed to a polymer composition that not only has excellent flame resistance, but also displays excellent thermal shock resistance. The polymer composition can also be formulated to have a relatively high comparative tracking index. The polymer composition is particularly well suited for producing metal overmolded parts such as those used in battery management systems and electric drive units in electric vehicles. The polymer composition contains a thermoplastic polymer, reinforcing fibers, and a crosslinked thermoplastic vulcanizate. In addition, the polymer composition can contain a flame retardant system that can comprise a phosphinate.

In one aspect, the present disclosure is directed to a polymer composition comprising one or more thermoplastic polymers present in the composition in an amount greater than about 20% by weight. The polymer composition further contains a flame retardant system comprising a metal phosphinate and a nitrogen-containing synergist. The flame retardant system is present in the polymer composition in an amount greater than about 12% by weight. The polymer composition further contains reinforcing fibers in an amount from about 5% by weight to about 50% by weight. In accordance with the present disclosure, the polymer composition further contains a crosslinked thermoplastic vulcanizate comprising a crosslinked ethylene polymer and an at least partially cured elastomer.

The crosslinked ethylene polymer, for instance, can be formed from an ethylene copolymer, such as from ethylene and a C₃ to C₈ alpha-olefin. The C₃ to C₈ alpha-olefin can comprise butene, hexene, octene, or mixtures thereof. The elastomer can comprise an ethylene/propylene/non-conjugated diene copolymer rubber (EPDM). The crosslinked thermoplastic vulcanizate can comprise from about 10% to about 90% by weight, such as from about 30% to about 65% by weight of the at least partially cured elastomer and from about 10% to about 90% by weight, such as from about 35% to about 70% by weight of the crosslinked ethylene polymer wherein the weight percent is based on the weight of the crosslinked thermoplastic vulcanizate. In one aspect, the elastomer is fully vulcanized. The crosslinked thermoplastic vulcanizate can exhibit a Shore A hardness (ISO Test 868:2003) of from about 25 to about 100, such as from about 50 to about 80. In one aspect, the crosslinked thermoplastic vulcanizate can be present in the polymer composition in an amount from about 2% by weight to about 12% by weight, such as in an amount from about 2.5% by weight to about 10% by weight, such as in an amount from about 2.5% by weight to about 8% by weight.

The thermoplastic polymer contained in the polymer composition can comprise a polyamide polymer, such as an aliphatic polyamide polymer. For instance, the polyamide polymer can comprise a polyamide 6 polymer, a polyamide 66 polymer, or mixtures thereof. One or more polyamide polymers can be present in the polymer composition in an amount from about 30% by weight to about 75% by weight.

The flame retardant system contained within the polymer composition contains a metal phosphinate, such as a metal dialkylphosphinate. The metal dialkylphosphinate, for instance, may comprise aluminum diethylphosphinate. The metal phosphinate can be present in the polymer composition in an amount from about 6% by weight to about 16% by weight. The nitrogen-containing synergist can comprise melamine or a melamine derivative. In one application, the nitrogen-containing synergist comprises melamine polyphosphate. The nitrogen-containing synergist can be present in the polymer composition in an amount from about 3% by weight to about 12% by weight.

In one aspect, the polymer composition can also contain an inorganic filler. The inorganic filler, for instance, may comprise zinc borate.

The polymer composition can also contain a compatibilizer. The compatibilizer, for instance, may comprise maleic anhydride.

The polymer composition of the present disclosure may display a thermal shock resistance of greater than about 250 cycles, such as greater than about 300 cycles, such as greater than about 350 cycles, such as greater than about 400 cycles, such as greater than about 450 cycles. The polymer composition can display a comparative tracking index of greater than about 550 volts, such as about 600 volts or greater. The polymer composition can also display a flame resistance rating according to UL-94 Test of V-O at a thickness of 0.8 mm or at a thickness of 0.4 mm.

The present disclosure is also directed to an overmolded article comprising a metallic substrate overmolded with the polymer composition as described above. The overmolded article can comprise a busbar, an inverter, a converter, a charging base, a relay box, or an electrical connector.

Other features and aspects of the present disclosure are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a perspective view of one embodiment of a metal overmolded article made in accordance with the present disclosure;

FIG. 2 is another embodiment of a metal overmolded article made in accordance with the present disclosure;

FIG. 3 is a perspective view of still another metal overmolded article made in accordance with the present disclosure;

FIG. 4 is a perspective view of one embodiment of a high voltage connector that can be made in accordance with the present disclosure; and

FIG. 5 is a perspective view of the metal overmolded part used during testing of Thermal Shock Resistance.

Repeat use of reference characters in the present specification and drawings is intended to represent the same or analogous features or elements of the present invention.

### DEFINITIONS

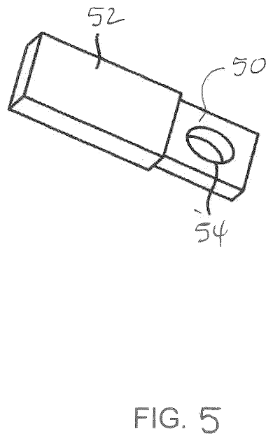

Thermal Shock Resistance: Thermal shock resistance is measured on a metal overmolded part and the test is described in WO 2023/150060 which is incorporated herein by reference. A metallic, stainless steel part having dimensions of 64 mm×20 mm×10 mm is overmolded with a polymer composition having a coating thickness of 1.2 mm. The metallic piece is included on one end with an aperture or hole having a diameter of 2 mm. The polymer coating covers two-thirds of the length of the metal part and leaves the aperture or hole exposed on one end. The test specimen is shown in FIG. 5 including the steel substrate 50, the coating 52, and the aperture 54. The test specimen is then placed in a two-zone thermal shock apparatus such as model ShockEvent T/120/V2 available from Weiss-Technik.

The thermal shock apparatus includes a heating chamber and a cooling chamber. The test specimen is first heated to a maximum temperature and then rapidly cooled to a minimum temperature over a 60-minute period. In one embodiment, the part can be heated to 140° C. and then cooled to −40° C. In another embodiment, the part can be heated to 105° C. and then cooled to −40° C. The heating chamber can have a heating rate of 14 K/min and can have a cooling rate of 2 K/min. The cooling chamber, on the other hand, can have a cooling rate of 6.3 K/min and can have a heating rate of 2 K/min. When conducting the thermal shock test, the sample is first placed in the heating chamber at ambient temperature. The temperature is increased to the target temperature (105° C. or 140° C.). After 30 min, the sample is placed in the cooling chamber, in which the temperature is already at −40° C. After another 30 min, the sample is transferred to the heating chamber again for the 2nd cycle, in which the temperature is already at 105° C. or 140° C. Thermal shock resistance is the number of thermal cycles until the overmolded sample displays a crack.

Comparative Tracking Index (“CTI”): The comparative tracking index (CTI) may be determined in accordance with International Standard IEC 60112-2003 to provide a quantitative indication of the ability of a composition to perform as an electrical insulating material under wet and/or contaminated conditions. In determining the CTI rating of a composition, two electrodes are placed on a molded test specimen. A voltage differential is then established between the electrodes while a 0.1% aqueous ammonium chloride solution is dropped onto a test specimen. The maximum voltage at which five (5) specimens withstand the test period for 50 drops without failure is determined. The test voltages range from 100 to 600 V in 25 V increments. The numerical value of the voltage that causes failure with the application of fifty (50) drops of the electrolyte is the “comparative tracking index.” The value provides an indication of the relative track resistance of the material. An equivalent method for determining the CTI is ASTM D-3638-12.

UL94: A specimen is supported in a vertical position and a flame is applied to the bottom of the specimen. The flame is applied for ten (10) seconds and then removed until flaming stops, at which time the flame is reapplied for another ten (10) seconds and then removed. Two (2) sets of five (5) specimens are tested. The sample size is a length of 125 mm, width of 13 mm, and thickness of 0.8 mm. The two sets are conditioned before and after aging. For unaged testing, each thickness is tested after conditioning for 48 hours at 23° C. and 50% relative humidity. For aged testing, five (5) samples of each thickness are tested after conditioning for 7 days at 70° C.

| Vertical | |
|---|---|
| Ratings | Requirements |
| V-0 | Specimens must not burn with flaming combustion for more than 10 seconds |
| | after either test flame application. |
| | Total flaming combustion time must not exceed 50 seconds for each set of 5 |
| | specimens. |
| | Specimens must not burn with flaming or glowing combustion up to the |
| | specimen holding clamp. |
| | Specimens must not drip flaming particles that ignite the cotton. |
| | No specimen can have glowing combustion remain for longer than 30 seconds |
| | after removal of the test flame. |
| V-1 | Specimens must not burn with flaming combustion for more than 30 seconds |
| | after either test flame application. |
| | Total flaming combustion time must not exceed 250 seconds for each set of 5 |
| | specimens. |
| | Specimens must not burn with flaming or glowing combustion up to the |
| | specimen holding clamp. |
| | Specimens must not drip flaming particles that ignite the cotton. |
| | No specimen can have glowing combustion remain for longer than 60 seconds |
| | after removal of the test flame. |
| V-2 | Specimens must not burn with flaming combustion for more than 30 seconds |
| | after either test flame application. |
| | Total flaming combustion time must not exceed 250 seconds for each set of 5 |
| | specimens. |
| | Specimens must not burn with flaming or glowing combustion up to the |
| | specimen holding clamp. |
| | Specimens can drip flaming particles that ignite the cotton. |
| | No specimen can have glowing combustion remain for longer than 60 seconds |
| | after removal of the test flame. |

Tensile Modulus, Tensile Stress, and Tensile Elongation at Break: Tensile properties may be tested according to ISO Test No. 527:2012 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 1 or 5 mm/min.

Flexural Modulus and Flexural Stress: Flexural properties may be tested according to ISO Test No. 178:2010 (technically equivalent to ASTM D790-10). This test may be performed on a 64 mm support span. Tests may be run on the center portions of uncut ISO 3167 multi-purpose bars. The testing temperature may be 23° C. and the testing speed may be 2 mm/min.

Unnotched Charpy Impact Strength: Unnotched Charpy properties may be tested according to ISO Test No. ISO 179-1:2010) (technically equivalent to ASTM D256-10, Method B). This test may be run using a Type 1 specimen size (length of 80 mm, width of 10 mm, and thickness of 4 mm). Specimens may be cut from the center of a multi-purpose bar using a single tooth milling machine. The testing temperature may be 23° C.

Notched Charpy Impact Strength: Notched Charpy properties may be tested according to ISO Test No. ISO 179-1:2010) (technically equivalent to ASTM D256-10, Method B). This test may be run using a Type A notch (0.25 mm base radius) and Type 1 specimen size (length of 80 mm, width of 10 mm, and thickness of 4 mm). Specimens may be cut from the center of a multi-purpose bar using a single tooth milling machine. The testing temperature may be 23° C. or −30° C.

### DETAILED DESCRIPTION

It is to be understood by one of ordinary skill in the art that the present discussion is a description of exemplary embodiments only and is not intended as limiting the broader aspects of the present invention.

In general, the present disclosure is directed to a thermoplastic polymer composition that is particularly well suited for forming metal overmolded articles. The metal overmolded articles can comprise various electronic components, such as those used to construct an electric vehicle or hybrid vehicle. Metal ovemolded parts made according to the present disclosure can also be used in all different types of electronic devices and systems.

The polymer composition of the present disclosure is formulated so as to not only display excellent flame resistant properties but also display thermal shock resistance. In addition, the polymer composition can also be formulated to display a high comparative tracking index.

In the past, problems were experienced in creating thermoplastic polymer compositions that not only had good flame resistant properties but also had good thermal shock resistance. In particular, when components were added to the polymer composition for improving flame resistance, the components may adversely impact the thermal shock resistance. Similarly, many modifiers used to improve thermal shock resistance can significantly degrade the fire resistant properties of the composition. Polymer compositions formulated according to the present disclosure, however, have unexpectedly found to have both excellent flame resistance in combination with excellent thermal shock resistance. In addition, and of significant advantage, the polymer composition can also display a relatively high comparative tracking index.

Thermal shock resistance is particularly desirable when producing metal overmolded parts in electrical systems. Metal overmolded parts, for instance, are widely used in battery management systems and in electric drive units in electric vehicles. The insulating polymer material that is used to coat a metallic part should provide good thermal shock resistance, which means that the polymer coating should show no cracks and maintain good electrical insulating properties after many thermal shock cycles. Polyamide polymers used in the past, for instance, have displayed a relatively poor thermal shock resistance. The present disclosure, however, overcomes the above problems and can be used to formulate polyamide compositions with excellent thermal shock resistance.

The polymer composition of the present disclosure generally comprises a thermoplastic polymer, such as one or more polyamide polymers, that form a polymer matrix when molded into an article. The thermoplastic polymer is combined with a flame retardant system that can comprise a metal phosphinate in combination with a nitrogen-containing synergist. Optionally, the polymer composition can also contain reinforcing fibers, such as glass fibers. In accordance with the present disclosure, the polymer composition further includes a crosslinked thermoplastic vulcanizate comprising a crosslinked ethylene polymer and an at least partially cured elastomer. The crosslinked thermoplastic vulcanizate has been found to improve thermal shock resistance without degrading the flame resistant properties of the composition.

Polymer compositions formulated in accordance with the present disclosure, for instance, can display a thermal shock resistance when measured over a temperature range of from −40° C. to 140° C. of greater than about 250 cycles, such as greater than about 300 cycles, such as greater than about 350 cycles, such as greater than about 400 cycles, such as even greater than about 450cycles. In comparison, in the past, many polyamide 6 glass-reinforced compositions displayed a thermal shock resistance of less than 100 thermal cycles while polyamide 66 glass-reinforced compositions displayed a thermal shock resistance of less than about 245 cycles.

In addition, the polymer composition of the present disclosure can be formulated so as to exhibit a VO rating as determined in accordance with UL 94 at a thickness of only 1.6 mm, such as only 0.8 mm, such as only 0.4 mm.

In addition to flame retardant properties and/or thermal shock resistance, the polymer composition of the present disclosure can also display excellent comparative tracking index properties. The comparative tracking index (CTI) is the maximum voltage, measured in volts, at which a material withstands 50 drops of contaminated water without tracking. Tracking is defined as the formation of conductive paths due to electrical stress, humidity, and contamination. The comparative tracking index test is an accelerated simulation to determine possible future failures that typically result in a short in electrical equipment using the polyamide polymer composition as an insulating material. Comparative tracking index can be measured according to Test IEC 60112:2020. The flame retardant polymer composition of the present disclosure can be formulated to display a comparative tracking index of 550 volts or more, such as 600 volts or more, such as 650 volts or more, such as 700 volts or more (and less than about 1000 volts).

The polymer composition of the present disclosure can also display excellent mechanical properties.

The polymer composition can display a Charpy notched impact strength at 23° C. of greater than about 7 kJ/m², such as greater than about 8 kJ/m², such as greater than about 9 kJ/m², such as greater than about 10 kJ/m², such as greater than about 11 kJ/m², such as greater than about 12 kJ/m², and generally less than about 40 kJ/m².

The polymer composition can display a tensile stress at break of greater than about 100 MPa, such as greater than about 110 MPa, such as greater than about 115 MPa, such as greater than about 120 MPa, and generally less than about 200 MPa. The polymer composition can display a tensile strain at break of greater than about 1.75%, such as greater than about 2%, such as greater than about 2.15%, and generally less than about 4%.

Due to the excellent flame resistance properties, excellent thermal shock resistance, and excellent mechanical properties, the polymer composition of the present disclosure is well suited for making all different types of articles and components.

The polymer composition is particularly well suited for producing all different types of electrical components. Such articles can include high voltage powertrain components and other devices that may be powered using lithium ion batteries. The polymer composition can serve as a housing for encasing the electrical component or can be an insulative component that directly surrounds an electrical contact pin or other conductive member. The present disclosure is particularly well suited for producing metal overmolded articles, such as inverters, converters, onboard charger bases, relay box frames, busbars, battery pack components, high voltage connectors, and the like.

Various embodiments of the present invention will now be described in more detail.

### I. Polymer Matrix

### A. Thermoplastic Polymer

The polymer matrix functions as a continuous phase of the composition and contains one or more thermoplastic polymers. Thermoplastic polymers well suited for use in the composition include polyamide polymers, polyarylene sulfide polymers, polyester polymers, and mixtures thereof. The one or more thermoplastic polymers can be present in the polymer matrix in an amount from about 20% by weight to about 90% by weight, including all increments of 1% by weight therebetween. For example, one or more thermoplastic polymers can be contained in the polymer composition in an amount greater than about 25% by weight, such as in an amount greater than about 30% by weight, such as in an amount greater than about 35% by weight and generally in an amount less than about 85% by weight, such as in an amount less than about 80% by weight, such as in an amount less than about 70% by weight, such as in an amount less than about 60% by weight, such as in an amount less than about 50% by weight, such as in an amount less than about 45% by weight.

Polyamides generally have a CO—NH linkage in the main chain and are obtained by condensation of a diamine and a dicarboxylic acid, by ring opening polymerization of lactam, or self-condensation of an amino carboxylic acid. For example, the polyamide may contain aliphatic repeating units derived from an aliphatic diamine, which typically has from 4 to 14 carbon atoms. Examples of such diamines include linear aliphatic alkylenediamines, such as 1,4-tetramethylenediamine, 1,6-hexanediamine, 1,7-heptanediamine, 1,8-octanediamine, 1,9-nonanediamine, 1,10-decanediamine, 1,11-undecanediamine, 1,12-dodecanediamine, etc.; branched aliphatic alkylenediamines, such as 2-methyl-1,5-pentanediamine, 3-methyl-1,5 pentanediamine, 2,2,4-trimethyl-1,6-hexanediamine, 2,4,4-trimethyl-1,6-hexanediamine, 2,4-dimethyl-1,6-hexanediamine, 2-methyl-1,8-octanediamine, 5-methyl-1,9-nonanediamine, etc.; as well as combinations thereof. Of course, aromatic and/or alicyclic diamines may also be employed. Furthermore, examples of the dicarboxylic acid component may include aromatic dicarboxylic acids (e.g., terephthalic acid, isophthalic acid, 2,6-naphthalenedicarboxylic acid, 2,7-naphthalenedicarboxylic acid, 1,4-naphthalenedicarboxylic acid, 1,4-phenylenedioxy-diacetic acid, 1,3-phenylenedioxy-diacetic acid, diphenic acid, 4,4′-oxydibenzoic acid, diphenylmethane-4,4′-dicarboxylic acid, diphenylsulfone-4,4′-dicarboxylic acid, 4,4′-biphenyldicarboxylic acid, etc.), aliphatic dicarboxylic acids (e.g., adipic acid, sebacic acid, etc.), and so forth. Examples of lactams include pyrrolidone, aminocaproic acid, caprolactam, undecanlactam, lauryl lactam, and so forth. Likewise, examples of amino carboxylic acids include amino fatty acids, which are compounds of the aforementioned lactams that have been ring opened by water.

In certain embodiments, an “aliphatic” polyamide is employed that is formed only from aliphatic monomer units (e.g., diamine and dicarboxylic acid monomer units). Particular examples of such aliphatic polyamides include, for instance, nylon-4 (poly-a-pyrrolidone), nylon-6 (polycaproamide), nylon-11 (polyundecanamide), nylon-12 (polydodecanamide), nylon-46 (polytetramethylene adipamide), nylon-66 (polyhexamethylene adipamide), nylon-610, and nylon-612. Nylon-6 and nylon-66 are particularly suitable. In one particular embodiment, for example, nylon-6 or nylon-66 may be used alone. In other embodiments, blends of nylon-6 and nylon-66 may be employed. When such a blend is employed, the weight ratio of nylon-6 to nylon-66 is typically from about 1:2 to about 1:8, such as from about 1:3 to about 1:6, such as from about 1:3 to about 1:5.

In one aspect, for instance, the polymer composition contains a nylon-66 polymer in an amount greater than about 10% by weight, such as in an amount greater than about 15% by weight, such as in an amount greater than about 20% by weight, and in an amount less than about 55% by weight, such as in an amount less than about 45% by weight, such as in an amount less than about 40% by weight, such as in an amount less than about 35% by weight. The nylon-66 polymer can be combined with a nylon-6 polymer. The nylon-6 polymer, in one aspect, can be present in the polymer composition in an amount greater than about 5% by weight, such as in an amount greater than about 8% by weight, and in an amount less than about 55% by weight, such as in an amount less than about 30% by weight, such as in an amount less than about 18% by weight.

It is also possible to optionally include aromatic monomer units in the polyamide such that it is considered semi-aromatic (contains both aliphatic and aromatic monomer units) or wholly aromatic (contains only aromatic monomer units). For instance, suitable semi-aromatic polyamides may include poly(nonamethylene terephthalamide) (PA9T), poly(nonamethylene terephthalamide/nonamethylene decanediamide) (PA9T/910), poly(nonamethylene terephthalamide/nonamethylene dodecanediamide) (PA9T/912), poly(nonamethylene terephthalamide/11-aminoundecanamide) (PA9T/11), poly(nonamethylene terephthalamide/12-aminododecanamide) (PA9T/12), poly(decamethylene terephthalamide/11-aminoundecanamide) (PA10T/11), poly(decamethylene terephthalamide/12-aminododecanamide) (PA10T/12), poly(decamethylene terephthalamide/decamethylene decanediamide) (PA10T/1010), poly(decamethylene terephthalamide/decamethylene dodecanediamide) (PA10T/1012), poly(decamethylene terephthalamide/tetramethylene hexanediamide) (PA10T/46), poly(decamethylene terephthalamide/caprolactam) (PA10T/6), poly(decamethylene terephthalamide/hexamethylene hexanediamide) (PA10T/66), poly(dodecamethylene terephthalamide/dodecamethylene dodecanediarnide) (PA12T/1212), poly(dodecamethylene terephthalamide/caprolactam) (PA12T/6), poly(dodecamethylene terephthalamide/hexamethylene hexanediamide) (PA12T/66), and so forth.

In one embodiment, the polymer composition contains primarily or only aliphatic polyamide polymers that may be blended with one or more semi-aromatic polyamide polymers or a wholly aromatic polyamide polymer. In other embodiments, the polymer composition may only contain semi-aromatic polyamide polymers, may only contain wholly aromatic polyamide polymers, or may only contain a combination of semi-aromatic polyamide polymers and wholly aromatic polyamide polymers.

The polyamide employed in the polymer composition is typically crystalline or semi-crystalline in nature and thus has a measurable melting temperature. The melting temperature may be relatively high such that the composition can provide a substantial degree of heat resistance to a resulting part. For example, the polyamide may have a melting temperature of about 220° C. or more, in some embodiments from about 240° C. to about 325° C., and in some embodiments, from about 250° C. to about 335° C. The polyamide may also have a relatively high glass transition temperature, such as about 30° C. or more, in some embodiments about 40° C. or more, and in some embodiments, from about 45° C. to about 140° C. The glass transition and melting temperatures may be determined as is well known in the art using differential scanning calorimetry (“DSC”), such as determined by ISO Test No. 11357-2:2013 (glass transition) and 11357-3:2011 (melting).

### B. Flame Retardant System

In addition to one or more thermoplastic polymers, the polymer matrix may also contain a flame retardant system to help achieve the desired flammability performance. In one aspect, the flame retardant system of the present disclosure only contains two flame retardant components, although in other embodiments various other components may be added. Excellent flame resistant properties in combination with excellent melt processing characteristics can be obtained by incorporating into the polymer composition a non-halogen flame retardant in combination with a synergist.

In one embodiment, the flame retardant system of the present disclosure contains a metal phosphinate in combination with a synergist. In one aspect, the synergist can comprise a polyphosphate and/or a melamine or melamine derivative. The synergist, for instance, can comprise a nitrogen-containing polyphosphate, such as a melamine polyphosphate. In one aspect, the synergist can comprise a metal salt of a phosphonic acid, a phosphonic acid, or mixtures thereof.

The amount of flame retardant system incorporated into the polymer composition can vary depending upon the particular application and the desired result. In general, the flame retardant system is present in the polymer composition in an amount greater than about 12% by weight, such as in an amount of greater than about 15% by weight, such as in an amount greater than about 18% by weight, such as in an amount greater than about 20% by weight, such as in an amount of greater than about 21% by weight. The flame retardant system is generally present in the composition in an amount less than about 30% by weight, such as in an amount less than about 28% by weight, such as in an amount less than about 25% by weight.

As described above, the flame retardant system can include a

phosphinate flame retardant, such as a metal phosphinate. Such phosphinates are typically salts of a phosphinic acid and/or diphosphinic acid, such as those having the general formula (I) and/or formula (II):

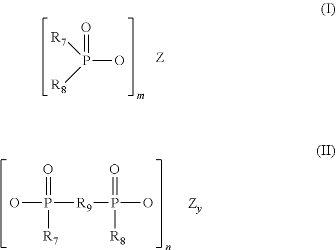

wherein,
R₇ and R₈ are, independently, hydrogen or substituted or unsubstituted, straight chain, branched, or cyclic hydrocarbon groups (e.g., alkyl, alkenyl, alkynyl, aralkyl, aryl, alkaryl, etc.) having 1 to 6 carbon atoms, particularly alkyl groups having 1 to 4 carbon atoms, such as methyl, ethyl, n-propyl, iso-propyl, n-butyl, or tert-butyl groups;
R₉ is a substituted or unsubstituted, straight chain, branched, or cyclic C₁-C₁₀ alkylene, arylene, arylalkylene, or alkylarylene group, such as a methylene, ethylene, n-propylene, iso-propylene, n-butylene, tert-butylene, n-pentylene, n-octylene, n-dodecylene, phenylene, naphthylene, methylphenylene, ethylphenylene, tert-butylphenylene, methylnaphthylene, ethylnaphthylene, t-butylnaphthylene, phenylethylene, phenylpropylene or phenylbutylene group;
Z is Mg, Ca, Al, Sb, Sn, Ge, Ti, Zn, Fe, Zr, Ce, Bi, Sr, Mn, Li, Na, K, and/or a protonated nitrogen base;
y is from 1 to 4, and preferably 1 to 2 (e.g., 1);
n is from 1 to 4, and preferably 1 to 2 (e.g. 1); and
m is from 1 to 4 and preferably 1 to 2 (e.g., 2).

The phosphinates may be prepared using any known technique, such as by reacting a phosphinic acid with a metal carbonate, metal hydroxide, or metal oxides in aqueous solution. Particularly suitable phosphinates include, for example, metal salts of dimethylphosphinic acid, ethylmethylphosphinic acid, diethylphosphinic acid, methyl-n-propylphosphinic acid, methane-di(methylphosphinic acid), ethane-1,2-di (methylphosphinic acid), hexane-1,6-di(methylphosphinic acid), benzene-1,4-di (methylphosphinic acid), methylphenylphosphinic acid, diphenylphosphinic acid, hypophosphoric acid, etc. The resulting salts are typically monomeric compounds; however, polymeric phosphinates may also be formed. Particularly suitable metals for the salts may include Al and Zn. For instance, one particularly suitable phosphinate is zinc diethylphosphinate. Another particularly suitable phosphinate is aluminum diethylphosphinate.

One or more metal phosphinates can generally be present in the polymer composition in an amount greater than about 6% by weight, such as in an amount greater than about 8% by weight, such as in an amount greater than about 10% by weight. One or more metal phosphinates are generally present in the polymer composition in an amount less than about 20% by weight, such as in an amount less than about 18% by weight, such as in an amount less than about 15% by weight.

In accordance with the present disclosure, the metal phosphinate is combined with a synergist. The synergist can comprise a polyphosphate, such as a nitrogen-containing polyphosphate. The polyphosphate may have the following general formula:

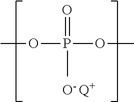

v is from 1 to 1000, in some embodiments from 2 to 500, in some embodiments from 3 to 100, and in some embodiments, from 5 to 50; and Q is a nitrogen base. Suitable nitrogen bases may include those having a substituted or unsubstituted ring structure, along with at least one nitrogen heteroatom in the ring structure (e.g., heterocyclic or heteroaryl group) and/or at least one nitrogen-containing functional group (e.g., amino, acylamino, etc.) substituted at a carbon atom and/or a heteroatom of the ring structure. Examples of such heterocyclic groups may include, for instance, pyrrolidine, imidazoline, pyrazolidine, oxazolidine, isoxazolidine, thiazolidine, isothiazolidine, piperidine, piperazine, thiomorpholine, etc. Likewise, examples of heteroaryl groups may include, for instance, pyrrole, imidazole, pyrazole, oxazole, isoxazole, thiazole, isothiazole, triazole, furazan, oxadiazole, tetrazole, pyridine, diazine, oxazine, triazine, tetrazine, and so forth. If desired, the ring structure of the base may also be substituted with one or more functional groups, such as acyl, acyloxy, acylamino, alkoxy, alkenyl, alkyl, amino, aryl, aryloxy, carboxyl, carboxyl ester, cycloalkyl, hydroxyl, halo, haloalkyl, heteroaryl, heterocyclyl, etc. Substitution may occur at a heteroatom and/or a carbon atom of the ring structure. For instance, one suitable nitrogen base may be a triazine in which one or more of the carbon atoms in the ring structure are substituted by an amino group. One particularly suitable base is melamine, which contains three carbon atoms in the ring structure substituted with an amino functional group. Such bases may form a melamine polyphosphate.

The polyphosphate synergist can generally be present in the polymer composition in an amount greater than about 5% by weight, such as in an amount greater than about 6% by weight, such as in an amount greater than about 7% by weight, such as in an amount greater than about 8% by weight, and generally less than about 20% by weight, such as in an amount less than about 15% by weight, such as in an amount less than about 12% by weight.

In accordance with the present disclosure, relatively great amounts of synergists can be present in the polymer composition in relation to the metal phosphinate. For instance, the metal phosphinate can be present in the polymer composition in relation to the synergist at a weight ratio of from about 1.5:1 to about 1:2, such as from about 1.3:1 to about 1:1.5, such as from about 1.3:1 to about 1:1.

In one aspect, the polymer composition can contain a first synergist and a second synergist. The first synergist can be the same or can be different than the second synergist. The first synergist can be compounded with the metal phosphinate and then combined with the thermoplastic polymer. The second synergist, on the other hand, can be optionally combined with a carrier polymer and then melt blended with the other components or melt blended as a powder without a carrier polymer. The carrier polymer can, in one aspect, be the same type of polymer used to form the matrix of the polymer composition. For instance, if the primary matrix polymer of the polymer composition is a polyamide, the carrier polymer can also be a polyamide, such as nylon-6 or nylon-66. The second synergist can be combined with the carrier polymer such that the second synergist comprises from about 50% to about 70% by weight of the compounded component, while the carrier polymer comprises from about 30% to about 50% by weight of the compounded component.

As stated above, the first synergist can be the same as the second synergist. For instance, the first and second synergists can both comprise a melamine polyphosphate.

It is believed that there are various advantages and benefits to adding the first synergist precompounded with the metal phosphinate and adding the second synergist separately in producing a melt blended product. For instance, it is believed that adding the synergists separately allows for better dispersion of the synergists within the polymer composition, especially when the synergist is present at elevated levels. In addition, it is believed that adding the synergists as two separate components can improve processing of the melt blended product.

Optionally, the flame retardant system can also contain an inorganic compound. Suitable inorganic compounds (anhydrous or hydrates) may include, for instance, inorganic molybdates, such as zinc molybdate, calcium molybdate, ammonium octamolybdate, zinc molybdate-magnesium silicate, etc. Other suitable inorganic compounds may include inorganic borates, such as zinc borate, zinc phosphate, zinc hydrogen phosphate, zinc pyrophosphate, basic zinc chromate (VI) (zinc yellow), zinc chromite, zinc permanganate, silica, magnesium silicate, calcium silicate, calcium carbonate, titanium dioxide, magnesium dihydroxide, and so forth.

When present, one or more inorganic compounds can be present in the polymer composition in amounts less than about 2% by weight, such as in amounts less than about 1.5% by weight, such as in amounts less than about 1% by weight, such as in amounts less than about 0.9% by weight, and generally greater than about 0.05% by weight, such as greater than about 0.1% by weight, such as greater than about 0.2% by weight, such as greater than about 0.3% by weight.

### C. Reinforcing Fibers

The reinforcing fibers generally have a high degree of tensile strength relative to their mass. For example, the ultimate tensile strength of the fibers (determined in accordance with ASTM D2101) is typically from about 1,000 to about 15,000 MPa, in some embodiments from about 2,000 MPa to about 10,000 MPa, and in some embodiments, from about 3,000 MPa to about 6,000 MPa. The high strength fibers may be formed from materials that are also electrically insulative in nature, such as glass, ceramics (e.g., alumina or silica), etc., as well as mixtures thereof. Glass fibers are particularly suitable, such as E-glass, A-glass, C-glass, D-glass, AR-glass, R-glass, S1-glass, S2-glass, etc., and mixtures thereof. The inorganic fibers may have a relatively small median diameter, such as about 50 micrometers or less, in some embodiments from about 0.1 to about 40 micrometers, and in some embodiments, from about 2 to about 20 micrometers, such as determined using laser diffraction techniques in accordance with ISO 13320:2009 (e.g., with a Horiba LA-960 particle size distribution analyzer). It is believed that the small diameter of such fibers can allow their length to be more readily reduced during melt blending, which can further improve surface appearance and mechanical properties. After formation of the polymer composition, for example, the average length of the inorganic fibers may be relatively small, such as from about 10 to about 800 micrometers, in some embodiments from about 100 to about 700 micrometers, and in some embodiments, from about 200 to about 600 micrometers. The inorganic fibers may also have a relatively high aspect ratio (average length divided by nominal diameter), such as from about 1 to about 100, in some embodiments from about 10 to about 60, and in some embodiments, from about 30 to about 50.

The amount of reinforcing fibers contained in the polymer composition can depend upon the particular application and the desired results. In general, reinforcing fibers can be present in the polymer composition in an amount from about 5% by weight to about 55% by weight, including all increments of 1% by weight therebetween. For instance, reinforcing fibers can be present in the polymer composition in an amount greater than about 10% by weight, such as in an amount greater than about 15% by weight, such as in an amount greater than about 20% by weight, such as in an amount greater than about 23% by weight. Reinforcing fibers can be present generally in an amount less than about 35% by weight, such as in an amount less than about 30% by weight, such as in an amount less than about 28% by weight.

### D. Thermoplastic Vulcanizate

The thermoplastic vulcanizate contains an ethylene polymer and an at least partially cured elastomer. In this regard, the thermoplastic vulcanizate in one embodiment may be a crosslinkable thermoplastic vulcanizate. As defined herein, such crosslinkable thermoplastic vulcanizate comprises a crosslinkable ethylene polymer and an at least partially cured elastomer, in particular dispersed within the crosslinkable ethylene polymer. Accordingly, as defined herein, such crosslinkable ethylene polymer has not yet undergone a crosslinking step. In other words, such crosslinkable ethylene polymer may be an uncrosslinked ethylene polymer. Upon crosslinking, the crosslinkable thermoplastic vulcanizate will be converted to a crosslinked thermoplastic vulcanizate due to the crosslinkable ethylene polymer having been converted to a crosslinked ethylene polymer. In this regard, the crosslinked thermoplastic vulcanizate may comprise the crosslinked ethylene polymer and the at least partially cured elastomer, in particular dispersed within the crosslinked ethylene polymer.

### 1. Ethylene Polymer

As indicated above, the thermoplastic vulcanizate contains one or more ethylene polymers. In one embodiment, one ethylene polymer may be utilized within the thermoplastic vulcanizate. In other embodiments, the thermoplastic vulcanizate may include a mixture of ethylene polymers. For instance, more than one ethylene polymer, such as two or three ethylene polymers, may be utilized in the thermoplastic vulcanizate. Furthermore, the ethylene polymer may be a homopolymer or a copolymer. In one embodiment, the ethylene polymer may be a homopolymer (i.e., polyethylene homopolymer). In another embodiment, the ethylene polymer may be a copolymer (i.e., polyethylene copolymer). In a further embodiment, the ethylene polymer may include a mixture of a homopolymer and a copolymer.

In this regard, the ethylene polymer as a homopolymer may be formed by polymerizing ethylene. When the ethylene polymer is a copolymer, the copolymer may be formed by polymerizing ethylene and one or more alpha-olefins, such as one or more C₃-C₂₀ alpha-olefins, such as one or more C₃-C₁₂ alpha-olefins, such as one or more C₃-C₈ alpha-olefins. These alpha-olefins may include, but are not limited to, propylene, 1-butene, 1-hexene, 1-octene, 2-methyl-1-propene, 3-methyl-1-pentene, 4-methyl-1-pentene, 5-methyl-1-hexene, and mixtures thereof. In particular, the alpha-olefin may be propylene, 1-butene, 1-hexene, 1-octene, or a mixture thereof. In one embodiment, the additional monomer may comprise propylene. In another embodiment, the additional monomer may comprise 1-butene. In a further embodiment, the additional monomer may comprise 1-hexene. In an even further embodiment, the additional monomer may comprise 1-octene. Furthermore, the additional comonomer may be linear or branched.

In this regard, the ethylene polymer may be a copolymer formed from ethylene and propylene in one embodiment. In another embodiment, the ethylene polymer may be a copolymer formed from ethylene and a C₄-C₂₀ alpha-olefin, such as a C₄-C₁₂ alpha-olefin, such as a C₄-C₈ alpha-olefin. For instance, the alpha-olefin may include, but is not limited to, 1-butene, 1-hexene, 1-octene, 2-methyl-1-propene, 3-methyl-1-pentene, 4-methyl-1-pentene, 5-methyl-1-hexene or mixtures thereof. In this regard, the alpha-olefin may include 1-butene, 1-hexene, 1-octene, or a mixture thereof. In one embodiment, the ethylene polymer may be a copolymer formed from ethylene and at least one of 1-hexene and/or 1-butene. As one example, the ethylene polymer may be a copolymer formed from ethylene and 1-hexene. In another embodiment, the ethylene polymer may be a copolymer formed from ethylene and 1-butene. In a further embodiment, the ethylene polymer may be a copolymer formed from ethylene, propylene, and a C₄-C₈ alpha-olefin, such as 1-butene, 1-hexene, 1-octene, 2-methyl-1-propene, 3-methyl-1-pentene, 4-methyl-1-pentene, 5-methyl-1-hexene or mixtures thereof.

The ethylene copolymer may also be formed by polymerizing ethylene with a monomer other than an alpha-olefin. For example, in one embodiment, the ethylene copolymer may be formed from ethylene and styrene to provide a styrene-ethylene copolymer. In another embodiment, the ethylene copolymer may be formed from ethylene and one or more a, B-unsaturated acids and/or one or more α,β-unsaturated esters. An example of such an ethylene copolymer may include a polyethylene-acrylate copolymer. In this regard, suitable comonomers can include polar vinyl monomers such as acrylic acid and/or its salts (e.g., inorganic such as sodium, potassium, lithium, calcium, magnesium, aluminum, copper, nickel, iron, and the like; organic such as ammonium, mono-, di-, tri-, or tetra-alkylammonium, and the like; or a combination thereof), alkacrylic acids (e.g., methacrylic acid, ethacrylic acid, and the like) and/or its salts, alkyl acrylates (e.g., methyl acrylate, ethyl acrylate, n-propyl acrylate, isopropyl acrylate, n-butyl acrylate, isobutyl acrylate, and the like), alkacrylates (e.g., methacrylate, ethacrylate, and the like), alkyl alkacrylates (e.g., methyl methacrylate, ethyl methacrylate, methyl isobutylacrylate, and the like), vinyl acetate, anhydrides (e.g., maleic anhydride, crotonic anhydride, and the like), and the like, and combinations thereof.

Regardless, when the ethylene polymer is a copolymer, it should be understood that the primary monomer is ethylene. Accordingly, the ethylene content of the polymer may be more than 50 mol. %, such as 55 mol. % or more, such as 60 mol. % or more, such as 65 mol. % or more, such as 70 mol. % or more, such as 75 mol. % or more, such as 80 mol. % or more, such as 85 mol. % or more, such as 90 mol. % or more, such as 95 mol. % or more to less than 100 mol. %, such as 99 mol. % or less, such as 98 mol. % or less, such as 97 mol. % or less, such as 96 mol. % or less, such as 95 mol. % or less. Meanwhile, the comonomer, such as the C₃-C₂₀ alpha-olefin, may be present in an amount of less than 50 mol. %, such as 40 mol. % or less, such as 30 mol. % or less, such as 25 mol. % or less, such as 20 mol. % or less, such as 15 mol. % or less, such as 10 mol. % or less, such as 5 mol. % or less to more than 0 mol. %, such as 1 mol. % or more, such as 2 mol. % or more, such as 3 mol. % or more, such as 4 mol. % or more, such as 5 mol. % or more. Particularly, the propylene content of the polymer may be 20 mol. % or less, such as 15 mol. % or less, such as 10 mol. % or less, such as 5 mol. % or less, such as 3 mol. % or less, such as 2 mol. % or less, such as 1 mol. % or less, such as about 0 mol. %. The propylene content may be 0 mol. % or more, such as 0.01 mol. % or more, such as 0.05 mol. % or more, such as 0.1 mol. % or more. In one particular embodiment, the ethylene polymer may not be formed from any propylene.

In addition to the above, in one embodiment, the ethylene polymer may have a particular density. For instance, the density may be from about 0.80 g/cm³ to about 1 g/cm³, such as from about 0.84 g/cm³ to about 0.99 g/cm³, such as from about 0.84 g/cm³ to about 0.94 g/cm³, such as from about 0.85 g/cm³ to about 0.94 g/cm³, such as from about 0.91 g/cm³ to about 0.94 g/cm³. In this regard, the ethylene polymer may be a linear low density polyethylene (LLDPE), a low density polyethylene (LDPE), a medium density polyethylene (MDPE), a high density polyethylene (HDPE), or a mixture thereof. Such polyethylenes may have a particular density as determined in accordance with ASTM D792. For instance, a linear low density polyethylene (LLDPE) may have a density in the range of from about 0.91 g/cm³ to about 0.94 g/cm³. Meanwhile, a low density polyethylene (LDPE) may have a density in the range of from about 0.91 g/cm³ to about 0.925 g/cm³. A medium density polyethylene (MDPE) may have a density in the range of from about 0.926 g/cm³ to about 0.94 g/cm³. Also, a high density polyethylene (HDPE) may have density in the range of from about 0.941 g/cm³ to about 0.965 g/cm³. In one embodiment, the ethylene polymer may be a low density polyethylene. In another embodiment, the ethylene polymer may be a linear low density polyethylene. In a further embodiment, the ethylene polymer may be a medium density polyethylene.

In one embodiment, the ethylene polymer may be a low density polyethylene copolymer formed from ethylene and 1-butene. In another embodiment, the ethylene polymer may be linear low density polyethylene copolymer formed from ethylene and 1-butene. In a further embodiment, the ethylene polymer may be a medium density polyethylene copolymer formed from ethylene and 1-butene.

In one embodiment, the ethylene polymer may be low density polyethylene copolymer formed from ethylene and 1-hexene. In another further embodiment, the ethylene polymer may be linear low density polyethylene copolymer formed from ethylene and 1-hexene. In a further embodiment, the ethylene polymer may be a medium density polyethylene copolymer formed from ethylene and 1-hexene.

In one embodiment, the ethylene polymer may also include a functionalized ethylene polymer. The functionalized ethylene polymer in one embodiment may be present as the primary ethylene polymer. In another embodiment, the functionalized ethylene polymer may be present as a secondary ethylene polymer, for instance in an amount less than another ethylene polymer within the thermoplastic vulcanizate.

The functionalized ethylene polymer may include a polymer including at least one functional group. The functional group, which may also be referred to as a functional substituent or functional moiety, includes a hetero atom. In one or more embodiments, the functional group includes a polar group. Examples of polar groups include hydroxy, carbonyl, ether, halide, amine, imine, nitrile, silyl, epoxide, or isocyanate groups. Exemplary groups containing a carbonyl moiety include carboxylic acid, anhydride, ketone, acid halide, ester, amide, or imide groups, and derivatives thereof. In one embodiment, the functional group includes a succinic anhydride group, or the corresponding acid, which may derive from a reaction (e.g., polymerization or grafting reaction) with maleic anhydride, or a β-alkyl substituted propanoic acid group or derivative thereof.

In general, the ethylene polymer can include a solid, generally high molecular weight polymeric material. The ethylene polymer may have a Mw of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more, such as 2,000,000 g/mol or more, such as 3,000,000 g/mol or more. The Mw may be about 6,000,000 g/mol or less, such as about 5,000,000 g/mol or less, such as 4,000,000 g/mol or less, such as 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less. Furthermore, the ethylene polymer may have a Mn of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more, such as 2,000,000 g/mol or more, such as 3,000,000 g/mol or more. The Mn may be about 6,000,000 g/mol or less, such as about 5,000,000 g/mol or less, such as 4,000,000 g/mol or less, such as 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less. In general, the molecular weight may be characterized by GPC (gel permeation chromatography) using polystyrene standards.

The ethylene polymer may be a crystalline polymer in one embodiment or a semi-crystalline polymer in another embodiment. For instance, the crystallinity may be at least 25%, such as at least 35%, such as at least 45%, such as at least 55%, such as at least 65%, such as at least 70%, such as at least 75%, such as at least 80%, such as at least 85%, such as at least 90%, such as at least 95% by weight. The crystallinity may be about 100% in one embodiment. The crystallinity may be determined by differential scanning calorimetry. For instance, crystallinity may be determined by dividing the heat of fusion of a sample by the heat of fusion of a 100% crystalline polymer.

The ethylene polymer may also have a particular glass transition temperature (“Tg”). In this regard, the Tg may be about −130° C. or more, such as −120° C. or more, such as −110° C. or more, such as −100° C. or more, such as −90° C. or more, such as −70° C. or more, such as −50° C. or more, such as −30° C. or more, such as −25° C. or more, such as −20° C. or more, such as−15° C. or more, such as −10° C. or more, such as −5° C. or more, such as 0° C. or more, such as 5° C. or more, such as 10° C. or more, such as 20° C. or more, such as 30° C. or more, such as 50° C. or more, such as 80° C. or more. The Tg may be about 150° C. or less, such as 100° C. or less, such as 80° C. or less, such as 60° C. or less, such as 40° C. or less, such as 30° C. or less, such as 20° C. or less, such as 10° C. or less, such as 5° C. or less, such as 0° C. or less, such as −5° C. or less, such as −10° C. or less, such as −20° C. or less, such as −30° C. or less, such as −40° C. or less, such as −50° C. or less, such as −60° C. or less, such as −70° C. or less, such as −80° C. or less, such as −90° C. or less, such as −100° C. or less.

In addition, the ethylene polymer may have a particular melt temperature (“Tm”). For instance, the melt temperature of the ethylene polymer may be relatively high. Furthermore, the melt temperature of the ethylene polymer may be lower than the decomposition temperature of the elastomer in the thermoplastic vulcanizate, such decomposition temperature generally characterized as when the molecular bonds begin to break or scission such that the molecular weight of the elastomer begins to decrease. In this regard, the Tm may be about 30° C. or more, such as 40° C. or more, such as 50° C. or more, such as 60° C. or more, such as 70° C. or more, such as 80° C. or more, such as 90° C. or more, such as 100° C. or more, such as 110° C. or more, such as 120° C. or more, such as 130° C. or more, such as 140° C. or more, such as 150° C. or more. The Tm may be 250° C. or less, such as 200° C. or less, such as 180° C. or less, such as 160° C. or less, such as 150° C. or less, such as 140° C. or less, such as 130° C. or less, such as 120° C. or less, such as 110° C. or less. The melting temperature may be determined via DSC.

The ethylene polymer may also be characterized as having a particular heat of fusion. For instance, the heat of fusion may be about 0.1 J/g or more, such as about 1 J/g or more, such as about 2 J/g or more, such as about 5 J/g or more, such as about 10 J/g or more, such as about 10 J/g or more, such as about 30 J/g or more, such as 40 J/g or more, such as 50 J/g or more, such as 60 J/g or more, such as 70 J/g or more, such as 100 J/g or more, such as 120 J/g or more, such as 140 J/g or more, such as 160 J/g or more, such as 180 J/g or more, such as 200 J/g or more. The heat of fusion may be about 300 J/g or less, such as about 260 J/g or less, such as about 240 J/g or less, such as about 200 J/g or less, such as about 180 J/g or less, such as about 150 J/g or less, such as about 120 J/g or less, such as about 100 J/g or less, such as about 80 J/g or less, such as about 60J/g or less, such as about 50 J/g or less, such as about 40 J/g or less, such as about 30 J/g or less, such as about 20 J/g or less. The heat of fusion may be determined via DSC.

The ethylene polymer may have a melt flow rate of up to 400 g/10 min. In general, the ethylene polymer may have better properties where the melt flow rate is less than about 30 g/10 min., preferably less than 10 g/10 min, such as less than about 2 g/10 min, such as less than about 1 g/10 min, such as less than about 0.8 g/10 min. In general, the melt flow rate may be 0.1 g/10 min or more, such as 0.2 g/10 min or more, such as 0.3 g/10 min or more, such as 0.4 g/10 min or more, such as 0.5 g/10 min or more. Melt flow rate is a measure of how easily a polymer flows under standard pressure and is measured by using ASTM D-1238 at 190° C. and 2.16 kg load.

The ethylene polymer may also have a particular modulus of elasticity. For example, the modulus of elasticity may be 50 MPa or more, such as 100 MPa or more, such as 200 MPa or more, such as 300 MPa or more, such as 400 MPa or more, such as 500 MPa or more, such as 700 MPa or more, such as 1,000 MPa or more, such as 1,500 MPa or more, such as 2,000 MPa or more, such as 3,000 MPa or more. The modulus of elasticity may be 5,000 MPa or less, such as 4,500 MPa or less, such as 4,000 MPa or less, such as 3,500 MPa or less, such as 3,000 MPa or less, such as 2,500 MPa or less, such as 2,000 MPa or less, such as 1,500 MPa or less, such as 1,300 MPa or less, such as 1,000 MPa or less, such as 900 MPa or less, such as 800 MPa or less, such as 700 MPa or less, such as 600 MPa or less, such as 500 MPa or less, such as 400 MPa or less, such as 300 MPa or less, such as 200 MPa or less. The modulus of elasticity may be determined in accordance with ASTM D638-10.

The ethylene polymer may also have a particular 1% secant flexural modulus. For instance, the 1% secant flexural modulus may be 50 MPa or more, such as 100 MPa or more, such as 150 MPa or more, such as 200 MPa or more, such as 300 MPa or more, such as 400 MPa or more, such as 500 MPa or more. The 1% secant flexural modulus may be 1,500 MPa or less, such as 1,300 MPa or less, such as 1,000 MPa or less, such as 900 MPa or less, such as 800 MPa or less, such as 700 MPa or less, such as 600 MPa or less, such as 500 MPa or less, such as 400 MPa or less, such as 300 MPa or less, such as 200 MPa or less. The 1% secant flexural modulus may be determined in accordance with ASTM D882-18.

The ethylene polymer may also have a particular tensile strength at break. For instance, the ethylene polymer may exhibit a tensile strength at break of 1 MPa or more, such as 2 MPa or more, such as 3 MPa or more, such as 5 MPa or more, such as 10 MPa or more, such as 15 MPa or more, such as 20 MPa or more, such as 25 MPa or more, such as 30 MPa or more, such as 35 MPa or more, such as 40 MPa or more, such as 45 MPa or more. The tensile strength at break may be 150 MPa or less, such as 120 MPa or less, such as 100 MPa or less, such as 90 MPa or less, such as 80 MPa or less, such as 70 MPa or less, such as 60 MPa or less, such as 50 MPa or less, such as 40 MPa or less. The tensile strength at break may be determined in accordance with ASTM D882-18.

The ethylene polymer may also exhibit a desired elongation at break (or ultimate elongation). For instance, the elongation at break may be 100% or more, such as 200% or more, such as 300% or more, such as 400% or more, such as 500% or more, such as 550% or more, such as 600% or more, such as 650% or more, such as 700% or more, such as 750% or more. The ethylene polymer may be 1500% or less, such as 1300% or less, such as 1000% or less, such as 900% or less, such as 800% or less, such as 700% or less, such as 600% or less, such as 500% or less, such as 450% or less, such as 400% or less, such as 350% or less, such as 300% or less. The elongation at break may be determined in accordance with ASTM D882-18.

The thermoplastic vulcanizate can generally comprise about 5 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 50 wt. % or more, such as about 60 wt. % or more of the ethylene polymer. The thermoplastic vulcanizate may comprise about 90 wt. % or less, such as about 80 wt. % or less, such as about 70 wt. % or less, such as about 60 wt. % or less, such as about 50 wt. % or less, such as about 40 wt. % or less, such as about 30wt. % or less, such as about 20 wt. % or less, such as about 15 wt. % or less of the ethylene polymer. In one embodiment, such weight percentages may be based on the weight of the thermoplastic vulcanizate. In another embodiment, such aforementioned weight percentages may be based on the combined weight of the ethylene polymer and the elastomer combined. Furthermore, the aforementioned thermoplastic vulcanizate may be in reference to the crosslinkable thermoplastic vulcanizate in one embodiment. In another embodiment, the aforementioned thermoplastic vulcanizate may be in reference to the crosslinked thermoplastic vulcanizate.

Stated in another manner, the ethylene polymer may be present in an amount of 10 phr or more, such as 15 phr or more, such as 20 phr or more, such as 25 phr or more, such as 30 phr or more, such as 40 phr or more, such as 50 phr or more, such as 60 phr or more, such as 70 phr or more, such as 80 phr or more. The ethylene polymer may be present in an amount of 200 phr or less, such as 150 phr or less, such as 120 phr or less, such as 100 phr or less, such as 90 phr or less, such as 80 phr or less, such as 70 phr or less, such as 60 phr or less, such as 50 phr or less, such as 40 phr or less, such as 30 phr or less. Such content of ethylene polymer may be in reference to the crosslinkable ethylene polymer in the crosslinkable thermoplastic vulcanizate in one embodiment. In another embodiment, such content of ethylene polymer may be in reference to the crosslinked ethylene polymer in the crosslinked thermoplastic vulcanizate.

Furthermore, the thermoplastic vulcanizate may comprise 20 wt. % or less, such as 15 wt. % or less, such as 10 wt. % or less, such as 5 wt. % or less, such as 4 wt. % or less, such as 3 wt. % or less, such as 2 wt. % or less, such as 1 wt. % or less, such as 0.5 wt. % or less, such as about 0 wt. % of a thermoplastic resin that is a propylene polymer. The propylene polymer may be present in an amount of 0 wt. % or more. In one embodiment, the propylene polymer may be present in an amount of about 0 wt. %. For the sake of clarity, such propylene polymer generally considered a thermoplastic shall be distinguished from any elastomer component defined herein comprising a propylene monomer. Such amount of propylene polymer may be in reference to the crosslinkable thermoplastic vulcanizate and/or crosslinked thermoplastic vulcanizate. For instance, such propylene polymer may be a thermoplastic including 50 mol. % or more, such as 60 mol % or more, such as 70 mol. % or more, such as 80 mol. % or more, such as 85 mol. % or more, such as 90 mol. % or more, such as 95 mol. % or more of propylene units.

Furthermore, the method of making the ethylene polymer as utilized herein is not limited. For instance, the ethylene polymer may be synthesized using any polymerization technique known in the art such as, but not limited to, the Phillips catalyzed reactions, conventional Ziegler-Natta type polymerizations, and metallocene catalysis including, but not limited to, metallocene-alumoxane and metallocene-ionic activator catalysis. Suitable catalyst systems thus include chiral metallocene catalyst systems, see, e.g., U.S. Pat. No. 5,441,920, and transition metal-centered, heteroaryl ligand catalyst systems, see, e.g., U.S. Pat. No. 6,960,635.

### 2. Elastomer

As indicated above, the thermoplastic vulcanizate contains an elastomer. In general, any elastomer suitable for use in the manufacture of TPVs can be utilized in accordance with the present disclosure. In one embodiment, one elastomer may be utilized as the elastomer. In other embodiments, the elastomer may include a mixture of elastomers. For instance, more than one elastomer, such as two or three elastomers, may be utilized in the thermoplastic vulcanizate.

Any elastomer or mixture thereof that is capable of being vulcanized (that is crosslinked or cured) can be used as the elastomer (also referred to herein sometimes as the rubber). Reference to a rubber or elastomer may include mixtures of more than one. Some non-limiting examples of these rubbers include polyolefin copolymer elastomers, butyl rubber, natural rubber, styrene-butadiene copolymer rubber (e.g., styrene/ethylene-butadiene/styrene), butadiene rubber, acrylonitrile rubber, halogenated rubber such as brominated and chlorinated isobutylene-isoprene copolymer rubber, butadiene-styrene-vinyl pyridine rubber, urethane rubber, polyisoprene rubber, epichlolorohydrin terpolymer rubber, and polychloroprene.

Vulcanizable elastomers includes polyolefin copolymer elastomers. These copolymers are made from one or more of ethylene and higher alpha-olefins, which may include, but are not limited to propylene, 1-butene, 1-hexene, 4-methyl-1 pentene, 1-octene, 1-decene, or combinations thereof. An example of such a copolymer elastomer may include an ethylene propylene rubber. Furthermore, in addition to the ethylene and the higher alpha-olefin, the elastomer may also contain one or more copolymerizable, multiply unsaturated comonomers, such as diolefins, or diene monomers. The alpha-olefins can be propylene, 1-hexene, 1-octene, or combinations thereof. These rubbers may lack substantial crystallinity and can be suitably amorphous copolymers.

The diene monomers may include, but are not limited to, 5-ethylidene-2-norbornene; 1,4-hexadiene; 5-methylene-2-norbornene; 1,6-octadiene; 5-methyl-1,4-hexadiene; 3,7-dimethyl-1,6-octadiene; 1,3-cyclopentadiene; 1,4-cyclohexadiene; dicyclopentadiene; 5-vinyl-2-norbornene, divinyl benzene, and the like, or a combination thereof. The diene monomers can be 5-ethylidene-2-norbornene and/or 5-vinyl-2-norbornene. If the copolymer is prepared from ethylene, alpha-olefin, and diene monomers, the copolymer may be referred to as a terpolymer (EPDM rubber), or a tetrapolymer in the event that multiple alpha-olefins or dienes, or both, are used (EAODM rubber).

Elastomers that are polyolefin elastomer copolymers can contain from about 15 to about 90 mole percent ethylene units deriving from ethylene monomer, from about 40 to about 85 mole percent, or from about 50 to about 80 mole percent ethylene units. The copolymer may contain from about 10 to about 85 mole percent, or from about 15 to about 50 mole percent, or from about 20 to about 40 mole percent, alpha-olefin units deriving from alpha-olefin monomers. The foregoing mole percentages are based upon the total moles of the momomer units of the polymer. Where the copolymer contains diene units, the copolymers may contain from 0.1 to about 14 weight percent, from about 0.2 to about 13weight percent, or from about 1 to about 12 weight percent units deriving from diene monomer. The weight percent diene units deriving from diene may be determined according to ASTM D-6047. In some occurrences, the copolymers contain less than 5.5 weight percent, such as less than 5.0 weight percent, such as less than 4.5 weight percent, such as less than 4.0 weight percent units deriving from diene monomer. In yet other cases, the copolymers contain greater than 6.0 weight percent, such as greater than 6.2 weight percent, such as greater than 6.5 weight percent, such as greater than 7.0 weight percent units, such as greater than 8.0 weight percent deriving from diene monomer.

The polyolefin elastomer copolymer may be obtained using polymerization techniques known in the art such as traditional solution or slurry polymerization processes. For instance, the catalyst employed to polymerize the ethylene, alpha-olefin, and diene monomers into elastomeric copolymers can include both traditional Ziegler-Natta type catalyst systems, especially those including titanium and vanadium compounds, as well as metallocene catalysts for Group 3-6 (titanium, zirconium and hafnium) metallocene catalysts, particularly the bridged mono-or biscyclopentadienyl metallocene catalysts. Other catalyst systems such as Brookhart catalyst systems may also be employed.

In one embodiment, the elastomer may include a butyl rubber. For instance, the butyl rubber includes copolymers and terpolymers of isobutylene and at least one other comonomer. Useful comonomers include isoprene, divinyl aromatic monomers, alkyl substituted vinyl aromatic monomers, and mixtures thereof. Exemplary divinyl aromatic monomers include vinyl styrene. Exemplary alkyl substituted vinyl aromatic monomers include α-methyl styrene and paramethyl styrene. These copolymers and terpolymers may also be halogenated such as in the case of chlorinated and brominated butyl rubber. In one or more embodiments, these halogenated polymers may derive from monomers such as parabromomethylstyrene.

In one or more embodiments, the butyl rubber includes copolymers of isobutylene and isoprene, copolymers of isobutylene and paramethyl styrene, terpolymers of isobutylene, isoprene, and divinyl styrene, branched butyl rubber, and brominated copolymers of isobutene and paramethylstyrene (yielding copolymers with parabromomethylstyrenyl mer units). These copolymers and terpolymers may be halogenated. Furthermore, butyl rubbers may be prepared by polymerization, using techniques known in the art such as at a low temperature in the presence of a Friedel-Crafts catalyst.

In one embodiment, where the butyl rubber includes the isobutylene-isoprene copolymer, the copolymer may include from about 0.5 to about 30, or from about 0.8 to about 5, percent by weight isoprene based on the entire weight of the copolymer with the remainder being isobutylene. In another embodiment, where the butyl rubber includes isobutylene-paramethyl styrene copolymer, the copolymer may include from about 0.5 to about 25, and from about 2 to about 20, percent by weight paramethyl styrene based on the entire weight of the copolymer with the remainder being isobutylene. In one embodiment, isobutylene-paramethyl styrene copolymers can be halogenated, such as with bromine, and these halogenated copolymers can contain from about 0 to about 10 percent by weight, or from about 0.3 to about 7 percent by weight halogenation.

In other embodiments, where the butyl rubber includes isobutylene-isoprene-divinyl styrene, the terpolymer may include from about 95 to about 99, or from about 96 to about 98.5, percent by weight isobutylene, and from about 0.5 to about 5, or from about 0.8 to about 2.5, percent by weight isoprene based on the entire weight of the terpolymer, with the balance being divinyl styrene.

In the case of halogenated butyl rubbers, the butyl rubber may include from about 0.1 to about 10, or from about 0.3 to about 7, or from about 0.5 to about 3 percent by weight halogen based upon the entire weight of the copolymer or terpolymer.

In one or more embodiments, the glass transition temperature (Tg) of the butyl rubber can be less than about −55° C., or less than about−58° C., or less than about −60° C., or less than about −63° C. Also, the Mooney viscosity (ML₁₊₈@125° C.) of the butyl rubber can be from about 25 to about 75, or from about 30 to about 60, or from about 40 to about 55.

In general, the elastomer, in particular the polyolefin elastomer copolymer, may have a Mw of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more. The Mw may be about 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less, such as 600,000 g/mol or less, such as 500,000 g/mol or less, such as 400,000 g/mol or less, such as 300,000 g/mol or less. Furthermore, the elastomer, in particular the polyolefin elastomer copolymer, may have a Mn of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more. The Mn may be about 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less, such as 600,000 g/mol or less, such as 500,000 g/mol or less, such as 400,000 g/mol or less, such as 300,000 g/mol or less. In general, the molecular weight may be characterized by GPC (gel permeation chromatography) using polystyrene standards.

The thermoplastic vulcanizate can generally comprise about 2 wt. % or more, such as about 5 wt. % or more, such as about 10 wt. % or more, such as about 15 wt. % or more, such as about 20 wt. % or more, such as about 25 wt. % or more, such as about 30 wt. % or more, such as about 40 wt. % or more, such as about 50 wt. % or more of the elastomer. The thermoplastic vulcanizate may comprise about 90wt. % or less, such as about 80 wt. % or less, such as about 70 wt. % or less, such as about 60 wt. % or less, such as about 50 wt. % or less, such as about 40 wt. % or less, such as about 35 wt. % or less, such as about 30 wt. % or less, such as about 25 wt. % or less, such as about 20 wt. % or less, such as about 15 wt. % or less of the elastomer. In another embodiment, such aforementioned weight percentages may be based on the combined weight of the ethylene polymer and the elastomer combined in the thermoplastic vulcanizate.

Furthermore, when a mixture of elastomers is present, the primary elastomer may be present in an amount of about 60 wt. % or more, such as about 70 wt. % or more, such as about 80 wt. % or more, such as about 90 wt. % or more to less than 100 wt. % based on the weight of the elastomer. The secondary elastomer may be present in an amount of 40 wt. % or less, such as 30 wt. % or less, such as 20 wt. % or less, such as 15 wt. % or less, such as 10 wt. % or less, such as 5 wt. % or more to more than 0 wt. % of the elastomer.

### 3. Curing Composition

As indicated herein, the TPV formulation, in particular the elastomer within the formulation, may undergo dynamic vulcanization wherein the elastomer is at least partially cured. In general, any curing agent that is capable of curing or crosslinking the elastomer may be used. Some non-limiting examples of these curing agents include phenolic resins, peroxides, maleimides, and silicon-containing curing agents. In one particular embodiment, the curing agents may include phenolic resins, maleimides, and/or silicon-containing curing agents. In a further embodiment, the curing agents may include phenolic resins and/or silicon-containing curing agents. In this regard, in one embodiment, the vulcanization may be conducted without using any peroxides. For instance, this may allow for dynamic vulcanization of the rubber without crosslinking of the ethylene polymer.

The curing agents may be used with one or more coagents that serve as initiators, catalysts, etc. for purposes of improving the overall cure state of the elastomer. For instance, the curing composition of some embodiments includes one or both of zinc oxide (ZnO) and stannous chloride (SnCl₂).

In general, the phenolic resins may not necessarily be limited. For instance, these may include resole resins made by the condensation of alkyl substituted phenols or unsubstituted phenols with aldehydes, which can be formaldehydes, in an alkaline medium or by condensation of bi-functional phenoldialcohols. The alkyl substituents of the alkyl substituted phenols typically contain 1 to about 10 carbon atoms. Dimethylol phenols or phenolic resins, substituted in para-positions with alkyl groups containing 1 to about 10 carbon atoms can be used. These phenolic curing agents may be thermosetting resins and may be referred to as phenolic resin curing agents or phenolic resins. These phenolic resins may be ideally used in conjunction with a catalyst system. For example, non-halogenated phenol curing resins are used in conjunction with halogen donors and, optionally, a hydrogen halide scavenger. Where the phenolic curing resin is halogenated, a halogen donor is not required but the use of a hydrogen halide scavenger, such as ZnO, can be used.

Peroxide curing agents are generally selected from organic peroxides. Examples of organic peroxides include, but are not limited to, di-tert-butyl peroxide, dicumyl peroxide, t-butylcumyl peroxide, alpha, alpha-bis(tert-butylperoxy) diisopropyl benzene, 2,5 dimethyl 2,5-di(t-butylperoxy)hexane, 1,1-di(t-butylperoxy)-3,3,5-trimethyl cyclohexane, benzoyl peroxide, lauroyl peroxide, dilauroyl peroxide, 2,5-dimethyl-2,5-di(tert-butylperoxy)hexyne-3, and mixtures thereof. Also, diaryl peroxides, ketone peroxides, peroxydicarbonates, peroxyesters, dialkyl peroxides, hydroperoxides, peroxyketals and mixtures thereof may be used.

As indicated above, in one embodiment, the elastomer may not be cured using a peroxide curing agent. In this regard, it may be present in the TPV formulation in an amount of 0.5 wt. % or less, such as 0.2 wt. % or less, such as 0.1 wt. % or less, such as about 0 wt. %. In other words, it may be present in an amount of 2 phr or less, such as 1 phr or less, such as 0.5 phr or less, such as 0.1 phr or less, such as about 0 phr.

However, in another embodiment, the curing agent may be a peroxide curing agent. As indicated below, peroxides may also be utilized to crosslink the ethylene polymer. In this regard, the thermoplastic formulation may include a curing agent (e.g., for the elastomer) and a crosslinking agent (e.g., for the ethylene polymer) in certain embodiments. In such embodiments, a peroxide may be provided wherein such peroxide serves as both the crosslinking agent and the curing agent. The peroxide may be the same type of peroxide for both functions in one embodiment. In another embodiment, different peroxides, such as a first peroxide and a second peroxide, may be utilized.

The silicon-containing curing agents generally include silicon hydride compounds having at least two SiH groups. These compounds react with carbon-carbon double bonds of unsaturated polymers in the presence of a hydrosilylation catalyst. Silicon hydride compounds include, but are not limited to, methylhydrogen polysiloxanes, methylhydrogen dimethyl-siloxane copolymers, alkyl methyl polysiloxanes, bis(dimethylsilyl)alkanes, bis(dimethylsilyl)benzene, and mixtures thereof.

As noted above, hydrosilylation curing may be conducted in the presence of a catalyst. These catalysts can include, but are not limited to, peroxide catalysts and catalysts including transition metals of Group VIII. These metals include, but are not limited to, palladium, rhodium, and platinum, as well as complexes of these metals.

In certain embodiments, the curing composition also includes one or both of ZnO and SnCl₂. In one embodiment, the curing composition may include zinc oxide. In another embodiment, the curing composition may include stannous chloride. In a further embodiment, the curing composition may include zinc oxide and stannous chloride.

Coagents may also be employed with the curing agents. The coagent may include a multi-functional acrylate ester, a multi-functional methacrylate ester, or combination thereof. In other words, the coagents include two or more organic acrylate or methacrylate substituents. Examples of multi-functional acrylates include diethylene glycol diacrylate, trimethylolpropane triacrylate (TMPTA), ethoxylated trimethylolpropane triacrylate, propoxylated trimethylolpropane triacrylate, propoxylated glycerol triacrylate, pentaerythritol triacrylate, bistrimethylolpropane tetraacrylate, pentaerythritol tetraacrylate, ethoxylated pentaerythritol tetraacrylate, ethoxylated pentaerythritol triacrylate, cyclohexane dimethanol diacrylate, ditrimethylolpropane tetraacrylate, or combinations thereof. Examples of multi-functional methacrylates include trimethylol propane trimethacrylate (TMPTMA), ethylene glycol dimethacrylate, butanediol dimethacrylate, butylene glycol dimethacrylate, diethylene glycol dimethacrylate, polyethylene glycol dimethacrylate, allyl methacrylate, or combinations thereof. The coagent may also include triallylcyanurate, triallyl isocyanurate, triallyl phosphate, sulfur, N-phenyl-bis-maleamide, zinc diacrylate, zinc dimethacrylate, divinyl benzene, 1,2-polybutadiene, trimethylol propane trimethacrylate, tetramethylene glycol diacrylate, trifunctional acrylic ester, dipentaerythritolpentacrylate, polyfunctional acrylate, retarded cyclohexane dimethanol diacrylate ester, polyfunctional methacrylates, acrylate and methacrylate metal salts, oximer for e.g., quinone dioxime, and the like.

Furthermore, an oil can be employed in the cure system. The oil may also be referred to as a process oil, an extender oil, or plasticizer. Useful oils include mineral oils, synthetic processing oils, or combinations thereof and may act as plasticizers. The plasticizers include, but are not limited to, aromatic, naphthenic, and extender oils. Exemplary synthetic processing oils include low molecular weight polylinear alpha-olefins, and polybranched alpha-olefins. Suitable esters include monomeric and oligomeric materials having an average molecular weight below about 2,000 g/mole, or below about 600 g/mole. Specific examples include aliphatic mono- or diesters or alternatively oligomeric aliphatic esters or alkyl ether esters.

The curing composition may be added in one or more locations, including the feed hopper of a melt mixing extruder. In some embodiments, the curing agent and any additional coagents may be added to the TPV formulation together; in other embodiments, one or more coagents may be added to the TPV formulation at different times from any one or more of the curing agents, as the TPV formulation is undergoing processing to form a TPV.

In general, the amount of curing agent present should be sufficient to at least partially vulcanize the elastomer, and in some embodiments, to completely vulcanize the elastomer.

The crosslinked thermoplastic vulcanizate can be present in the polymer composition in an amount from about 1% by weight to about 30% by weight, including all increments of 1% by weight therebetween. For instance, the thermoplastic vulcanizate can be present in the polymer composition in an amount greater than about 2% by weight, such as in an amount greater than about 2.5% by weight, such as in an amount greater than about 3% by weight, such as in an amount greater than about 3.5% by weight, such as in an amount greater than about 4% by weight, such as in an amount greater than about 4.5% by weight, such as in an amount greater than about 5% by weight, such as in an amount greater than about 5.5% by weight, such as in an amount greater than about 6% by weight, such as in an amount greater than about 6.5% by weight, such as in an amount greater than about 7% by weight, such as in an amount greater than about 7.5% by weight, such as in an amount greater than about 8% by weight, and in an amount less than about 20% by weight, such as in an amount less than about 15% by weight, such as in an amount less than about 12% by weight, such as in an amount less than about 10% by weight, such as in an amount less than about 8% by weight.

### E. Other Components

In one aspect, the polymer composition can further contain at least one stabilizer. The stabilizer can include, for instance, an antioxidant.

The antioxidant, for instance, can be a phenolic antioxidant. In one embodiment, for instance, the composition can contain a phenolic antioxidant. Examples of such phenolic antioxidants include, for instance, calcium bis (ethyl 3,5-di-tert-butyl-4-hydroxybenzylphosphonate) (Irganox® 1425); terephthalic acid, 1,4-dithio-, S,S-bis (4-tert-butyl-3-hydroxy-2,6-dimethylbenzyl) ester (Cyanox® 1729); triethylene glycol bis (3-tert-butyl-4-hydroxy-5-methylhydrocinnamate); hexamethylene bis(3,5-di-tert-butyl-4-hydroxyhydrocinnamate (Irganox® 259); 1,2-bis(3,5,di-tert-butyl-4-hydroxyhydrocinnamoyl) hydrazide (Irganox® 1024); 4,4′-di -tert-octyldiphenamine (Naugalube® 438R); phosphonic acid, (3,5-di-tert-butyl-4-hydroxybenzyl)-,dioctadecyl ester (Irganox® 1093); 1,3,5-trimethyl-2,4,6-tris (3′,5′-di-tert-butyl-4′ hydroxybenzyl)benzene (Irganox® 1330); 2,4-bis(octylthio)-6-(4-hydroxy-3,5-di-tert-butylanilino)-1,3,5-triazine (Irganox® 565); isooctyl 3-(3,5-di -tert-butyl-4-hydroxyphenyl)propionate (Irganox® 1135); octadecyl 3-(3,5-di-tert -butyl-4-hydroxyphenyl)propionate (Irganox® 1076); 3,7-bis(1,1,3,3-tetramethylbutyl)-10H-phenothiazine (Irganox® LO 3); 2,2′-methylenebis(4-methyl-6-tert-butylphenol)monoacrylate (Irganox® 3052); 2-tert-butyl-6-[1-(3-tert-butyl-2-hydroxy-5-methylphenyl)ethyl]-4-methylphenyl acrylate (Sumilizer® TM 4039); 2-[1-(2-hydroxy-3,5-di-tert-pentylphenyl)ethyl]-4,6-di-tert-pentylphenyl acrylate (Sumilizer®) GS); 1,3-dihydro-2H-Benzimidazole (Sumilizer® MB); 2-methyl-4,6-bis[(octylthio)methyl]phenol (Irganox® 1520); N,N′-trimethylenebis-[3-(3,5-di-tert -butyl-4-hydroxyphenyl)propionamide (Irganox® 1019); 4-n-octadecyloxy-2,6-diphenylphenol (Irganox® 1063); 2,2′-ethylidenebis[4,6-di-tert-butylphenol] (Irganox® 129); N N′-hexamethylenebis(3,5-di-tert-butyl-4-hydroxyhydrocinnamamide) (Irganox® 1098); diethyl(3,5-di-tert-butyl-4-hydroxybenxyl)phosphonate (Irganox® 1222); 4,4′-di-tert-octyldiphenylamine (Irganox® 5057); N-phenyl-1-napthalenamine (Irganox® L 05); tris[2-tert-butyl-4-(3-ter-butyl-4-hydroxy-6-methylphenylthio)-5-methyl phenyl]phosphite (Hostanox® OSP 1); zinc dinonyidithiocarbamate (Hostanox® VP-ZNCS 1); 3,9-bis[1,1-dimethyl-2-[(3-tert-butyl-4-hydroxy-5-methylphenyl)propionyloxy]ethyl]-2,4,8,10-tetraoxaspiro [5.5]undecane (Sumilizer® AG80); pentaerythrityl tetrakis[3-(3,5-di-tert-butyl-4-hydroxyphenyl)propionate] (Irganox® 1010); ethylene-bis(oxyethylene)bis[3-(5-tert-butyl-4-hydroxy-m-tolyl)-propionate (Irganox® 245); 3,5-di-tert-butyl-4-hydroxytoluene (Lowinox BHT, Chemtura) and the like. In one embodiment, the antioxidant can be a reaction product of 2,4-di-tert-butylphenol, phosphorous trichloride, and 1,1′-biphenyl. In one aspect, the antioxidant comprises tetrakis(2,4-di-tert-butylphenyl)-4,4biphenyldiphosphonite. In one aspect, the antioxidant may comprises a phosphite. One example of a phosphite stabilizer is tris(2,4-di-tert-butylphenyl) phosphite. In one aspect, an antioxidant may be present that is a hindered phenolic antioxidant. The hindered phenolic antioxidant, for instance, may comprise N,N′-(hexane-1,6-diyl)bis[3-(3,5-di-tert-butyl-4-hydroxyphenyl) propanamide].

One or more antioxidants can be present in the polymer composition generally in an amount greater than about 0.05% by weight, such as in an amount greater than about 0.08% by weight, such as in an amount greater than about 0.1% by weight, such as in an amount greater than about 0.2% by weight, such as in an amount greater than about 0.4% by weight, and generally less than about 2% by weight, such as less than about 1.5% by weight, such as less than about 1% by weight, such as less than about 0.8% by weight, such as less than about 0.5% by weight, such as less than about 0.4% by weight.

The composition can optionally include a light stabilizer which may comprise a hindered amine light stabilizer. Examples of light stabilizers that may be incorporated into the present disclosure include a benzenedicarboxamide. In one aspect, the light stabilizer comprises N,N′-Bis(2,2,6,6-tetramethyl-4-piperidinyl)-1,3-benzenedicarboxamide. The light stabilizer may also comprise any compound which is derived from an alkylsubtituted piperidyl, piperidinyl or piperazinone compound or a substituted alkoxypiperidinyl. Other suitable HALS are those that are derivatives of 2,2, 6,6-tetramethyl piperidine. Preferred specific examples of HALS include: ˜ 2,2, 6,6-tetramethyl-4-piperidinone, ˜2,2, 6,6-tetramethyl-4-piperidinol, ˜bis-(2, 2, 6,6-tetramethyl-4-piperidinyl)-sebacate, ˜mixtures of esters of 2,2,6,6-tetramethyl-4-piperidinol and fatty acids, ˜bis-(2,2,6,6-tetramethyl-4-piperidinyl)-succinate, ˜bis-(1-octyloxy-2,2,6,6-tetramethyl-4-piperidinyl)-sebacate, ˜bis-(1,2,2,6,6-pentamethyl-4-piperidinyl)-sebacate, ˜tetrakis-(2,2,6,6-tetramethyl-4-piperidyl)-1,2,3,4-butane-tetracarboxylate, ˜N-butyl-2,2,6,6-tetramethyl-4-piperidinamine, ˜N,N′-bis-(2,2,6,6-tetramethyl-4-piperidyl)-hexane-1,6-diamine, ˜2.2′-[(2.2.6.6-tetramethyl-4-piperidinyl)-imino]-bis-[ethanol], ˜5-(2.2.6.6-tetramethyl-4-piperidinyl)-2-cyclo-undecyl-oxazole), ˜mixture of: 2,2,4,4 tetramethyl-21-oxo-7-oxa-3.20-diazadispiro [5.1.11.2] heneicosane-20-propionic acid dodecylester and 2.2.4.4 tetramethyl-21-oxo-7; oxa-3,20-diazadispiro[5,1,11,2]-heneicosane-20-propionic acid; tetradecyl ester, ˜diacetam 5 (CAS registration number: 76505-58-3), ˜propanedioic acid, [(4-methoxyphenyl) methylene]-, bis(1,2,2,6,6-pentamethyl-4-piperidinyl) ester, ˜1,3-benzendicarboxamide, N,N′-bis(2,2,6,6-tetramethyl-4-piperidinyl), ˜3-dodecyl-1-(2,2,6,6-tetramethyl-4-piperidyl)-pyrrolidin-2,5-dione, ˜formamide, N,N′-1,6-hexanediylbis [N-(2,2,6,6-tetramethyl-4-piperidinyl, ˜3-dodecyl-1-(1,2,2, 6,6-pentamethyl-4-piperidyl)-pyrrolidin-2,5-dione, ˜1,5-Dioxaspiro (5,5) undecane 3,3-dicarboxylic acid, bis(2,2,6,6-tetramethyl-4-peridinyl) ester, ˜1,5-Dioxaspiro (5,5) undecane 3,3-dicarboxylic acid, bis(1,2,2,6,6-pentamethyl-4-peridinyl) ester, ˜bis (1,2,2,6,6-penta methyl-4-piperidyl) (3,5-di-t-butyl-4-hydroxybenzyl)-butylpropanedioate, ˜tetrakis-(1,2,2,6,6-penta-methyl-4-piperidyl)-1,2,3,4-butane-tetra--carboxylate, ˜1,2,3,4-butanetetracarboxylic acid, tetrakis (2,2,6,6-tetramethyl-4-piperidinyl) ester, ˜1,2,3,4-butane-tetracarboxylic acid-1,2,3-tris (1,2,2,6,6-pentamethyl-4-piperidinyl)-4-tridecylester, ˜8-acetyl-3-dodecyl-7,7,9,9-tetra methyl-1,3,8-triazaspiro (4,5) decane-2,4-dione, ˜N-2,2,6,6-tetrametyl-4-piperidinyl-N-amino-oxamide, ˜4-acryloyloxy-1,2,2,6,6-pentamethyl-4-piperidine, ˜1,5,8,12-tetrakis [2′,4′-bis(1″,2″,2″,6″,6″-pentamethyl-4″-piperidinyl (butyl) amino)-1′,3′,5′-tr-iazin-6′-yl]-1,5,8, 12-tetraazadodecane, ˜1, 1′-(1,2-ethane-di-yl)-bis-(3,3′,5,5′-tetra-methyl-piperazinone) (Good rite 3034), ˜propane amide, 2-methyl-N-(2,2,6,6-tetramethyl-4-piperidinyl)-2- [(2,2,6,6-tetramethyl-4-piperidinyl) amino], ˜oligomer of N-(2-hydroxyethyl)-2,2,6,6-tetramethyl-4-piperidinol and succinic acid, ˜poly [[6- [(1,1,3,3-tetramethylbutyl) amino]-s-triazine-2,4-diyl] [2,2,6,6-tetram-ethyl-4-piperidinyl) imino] hexamethylene [(2,2,6,6-tetramethyl-4-piperidinyl) imino]], ˜poly [(6-morfoline-S-triazine-2.4-diyl) [(2.2.6.6-tetramethyl-4-piperidinyl)-imino] hexamethylene- [(2.2.6.6-tetram-ethyl-4-piperidinyl)-imino]], ˜poly[(6-morpholino-s-triazine-2.4-diyl) [1.2.2.6.6-penta-methyl-4-piperidyl) imino]-hexamethylene[(2,2,6,6 tetra-methyl-4-piperidyl) imino]], ˜poly methylpropyl-3-oxy-[4 (2.2.6.6-tetrametyl)-piperidinyl)]-siloxane copolymer of a-methylstyrene and n-(2.2.6.6-tetramethyl-piperidinyl)-4-maleimide and N-stearyl-maleimide, ˜1,2,3,4-butane tetracarboxylic acid, polymer with 8,8,8′,8′-tetramethyl-2,4,8,10-tetraoxaspiro [5,5] undecane-3,9-diethanol, 1,2,2, 6,6-pentamethyl-4-piperidinyl ester, ˜1,2, 3,4-butanetetracarboxylic acid, polymer with 8,8,8′,8′-tetramethyl-2,4,8,10-tetraoxaspiro [5,5] undecane-3,9-diethanol, 2,2,6,6-tetramethyl-4-piperidinyl ester, ˜oligomer of 7-Oxa-3,20-diazadispiro [5,1,11,2] heneicosan-21-one, 2,2,4,4-tetramethyl-20-(oxiranylmethyl), ˜1,3,5-Triazine-2,4,6-triamine, N, N″-[1,2-ethanediylbis [[[4,6-bis[butyl (1,2,2,6,6-pentamethyl-4-iperidinyl) amino]-1,3,5- triazine- -2-yl]imino]-3,1-propanediyl]]-bis[N. N″-dibutyl-N. N″-bis(1.2.2.6.6-pentamethyl-4-piperidinyl), ˜1.3-Propanediamine, N, N-1,2-ethanediylbis-, polymer with 2,4,6-trichloro-1,3,5-triazine, reaction products with N-butyl-2,2,6,6-tetramethyl-4-piperidinamine, ˜1.6-Hexanediamine, N,N′-bis(2,2,6,6-tetramethyl-4piperidinyl)-polymer with 2,4,6-trichloro-1,3,5-triazine, reaction products with N-butyl-1-butanamine and N-butyl-2,2,6,6-tetramethyl-4-piperidinamine, ˜2,9,11,13,15,22,24,26,27,28-Decaazatricyclo[21,3,1,110,14]octacosa-1 (27), 10,12,14(28),23,25-hexaene-12, 25-diamine, N,N′-bis(1,1,3,3-tetramethylbutyl)-2,9,15,22-tetrakis (2,2,6,6-tetramethyl-4-piperidinyl)-, ˜1,1,1″-(1,3,5-Triazine-2,4,6-triyltris ((cyclohexylimino)-2,1-ethanediyl) tris (3,3,5,5-tetramethylpiperazinone), ˜1,1,1″-(1,3,5-Triazine-2,4,6-triyltris((cyclohexylimino)-2,1-ethylenediyl) tris (3,3,4,5,5-tetramethylpiperazinone), ˜1,6-hexanediamine, N, N′-bis(2,2,6,6-tetramethyl-4-piperidinyl)-, polymer with 2,4,6-trichloro-1,3,5-triazine, reaction products with 3-bromo-1-propene, nbutyl-1-butanamine and N-butyl-2,2,6,6-tetramethyl-4-piperidinamine, oxidised, hydrogenated, ˜Alkenes, (C20-24)-4alpha-, polymers with maleic anhydride, reaction products with 2,2,6,6-tetramethyl-4-piperidinamine, ˜N-2,2,6,6-tetramethyl-4-piperidinyl-N-amino-oxamide; 4-acryloyloxy-1,2,2,6,6-pentamethyl-4-piperidine; HALS PB-41 or mixtures thereof.

One or more light stabilizers can generally be present in the composition in an amount greater than about 0.01% by weight, such as in an amount greater than about 0.05% by weight, such as in an amount greater than about 0.08% by weight, and generally in an amount less than about 2% by weight, such as in an amount less than about 1% by weight, such as in an amount less than about 0.8% by weight, such as in an amount less than about 0.5% by weight, such as in an amount less than about 0.3% by weight, such as in an amount less than about 0.2% by weight.

In one aspect, a lubricant can be present in the polymer composition. Any suitable lubricant can be incorporated into the polymer composition. In one aspect, the lubricant can comprise a partially saponified ester wax. For example, the lubricant can comprise a partially saponified ester wax of a C22 to C36 fatty acid. The fatty acid, for instance, can comprise a montan wax. In one aspect, the lubricant can contain 1-methyl-1,3-propanediyl esters. In another aspect, the lubricant can be a fatty acid amide, including fatty primary amides, fatty secondary amides, and the like. Other suitable lubricants include metal salts of fatty acids, such as calcium stearate, aluminum distearate, zinc stearate, magnesium stearate, and mixtures thereof. In one aspect, the lubricant can comprise pentaerythritol tetrastearate. In one embodiment, the polymer composition can contain pentaerythritol tetrastearate in combination with calcium stearate. The calcium stearate, for instance, can be present in relation to the pentaerythritol tetrastearate at a weight ratio of from about 1:1 to about 5:1, such as from about 1.5:1 to about 4:1. One or more lubricants can be present in the polymer composition generally in an amount greater than about 0.08% by weight, such as in an amount greater than about 0.1% by weight, such as in an amount greater than about 0.2% by weight, such as in an amount greater than about 0.4% by weight, such as in an amount greater than about 0.6% by weight, and generally in an amount less than about 3% by weight, such as in an amount less than about 2.5% by weight, such as in an amount less than about 2% by weight, such as in an amount less than about 1.5% by weight, such as in an amount less than about 1% by weight, such as in an amount less than about 0.8% by weight.

A compatibilizer may also be employed to enhance the compatibility of the different components. For instance, the compatibilizer can be used to increase the degree of adhesion between the reinforcing fibers in the polymer matrix and/or can be used to improve the degree of compatibility between the thermoplastic vulcanizate and the thermoplastic polymer. When employed, such compatibilizers typically constitute from about 0.1 wt. % to about 5 wt. %, in some embodiments from about 0.1 wt. % to about 4 wt. %, and in some embodiments, from about 0.2 wt. % to about 2 wt. % of the polymer composition. In certain embodiments, the compatibilizer may be a polyolefin compatibilizer that contains a polyolefin that is modified with a polar functional group. The polyolefin may be an olefin homopolymer (e.g., polypropylene) or copolymer (e.g., ethylene copolymer, propylene copolymer, etc.). The functional group may be grafted onto the polyolefin backbone or incorporated as a monomeric constituent of the polymer (e.g., block or random copolymers), etc. Particularly suitable functional groups include maleic anhydride, maleic acid, fumaric acid, maleimide, maleic acid hydrazide, a reaction product of maleic anhydride and diamine, dichloromaleic anhydride, maleic acid amide, etc. In one aspect, the compatibilizer may comprise maleic anhydride (without being attached to a polyolefin polymer).

In one embodiment, the polymer composition can contain silica particles. For instance, amorphous silica particles can be added to the polymer composition in an amount greater than about 0.01% by weight, such as in an amount greater than about 0.02% by weight, and in an amount less than about 1% by weight, such as in an amount less than about 0.5% by weight, such as in an amount less than about 0.1% by weight.

In one embodiment, a coloring agent may optionally be incorporated into the polymer composition. The coloring agent, for instance, can be a black pigment such as carbon black or a black dye. The coloring agent can be present in the polymer composition in an amount greater than about 0.5% by weight, such as in an amount greater than about 0.7% by weight, and in an amount less than about 2% by weight, such as in an amount less than about 1.5% by weight, such as in an amount less than about 1.3% by weight.

The polymer composition may generally be employed to form a shaped part using a variety of different techniques. Suitable techniques may include, for instance, injection molding, low-pressure injection molding, extrusion compression molding, gas injection molding, low-pressure gas injection molding, gas extrusion compression molding, extrusion molding, compression molding, gas compression molding, etc. For example, an injection molding system may be employed that includes a mold within which the fiber-reinforced composition may be injected. The time inside the injector may be controlled and optimized so that polymer matrix is not pre-solidified. When the cycle time is reached and the barrel is full for discharge, a piston may be used to inject the composition to the mold cavity.

The polymer composition of the present disclosure is particularly well suited for use in producing metal overmolded articles. For instance, a metal substrate can be overmolded with the polymer composition using any suitable coating technique, such as injection molding, extrusion, or the like.

### II. Applications

Due to its unique properties, the fiber-reinforced polymer composition of the present disclosure can be used in all different types of applications. For instance, the fiber-reinforced polymer composition displays excellent flame retardant properties with improved mechanical properties. In addition, the polymer composition of the present disclosure displays dramatically improved thermal shock resistance, especially in comparison to glass fiber-reinforced polyamide compositions formulated in the past. The polymer composition can produce articles at relatively low weights while having excellent dimensional control. Articles formed with the polymer composition can have relatively thin walls and can possess excellent impact resistance strength and high temperature performance. In addition, the polymer composition can be formulated to have excellent electrical properties.

For exemplary purposes only, in one aspect, the polymer composition can be used to produce components in various different electrical devices and systems.

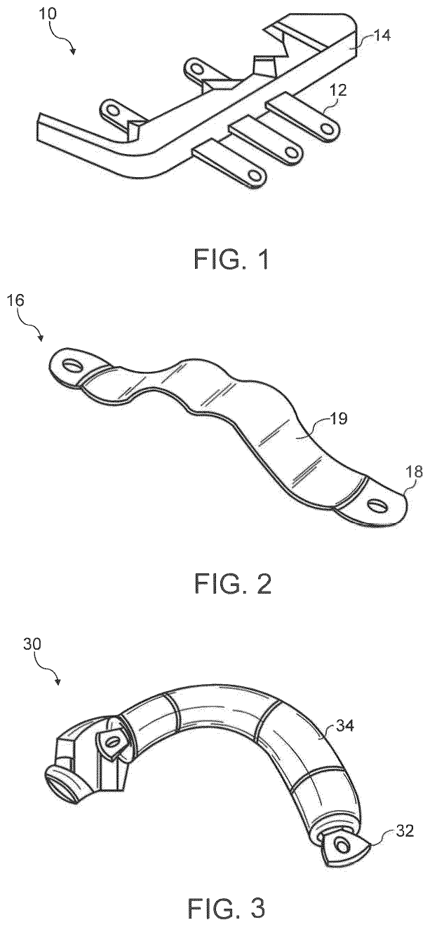

As described above, the polymer composition of the present disclosure is particularly well suited for producing metal overmolded articles, especially in electrical systems. The metal overmolded articles can comprise, for instance, inverters, converters, onboard charging bases, relay box frames, busbars, battery modules, battery packs, and the like. For example, as shown in FIG. 1, an inverter 10 is illustrated. The inverter 10 includes a metal substrate 12 coated with a polymer composition 14 in accordance with the present disclosure.

FIG. 2 illustrates a battery module 16 for interconnecting batteries. The battery module includes a metal substrate or conductive member 18. The metal substrate 18 includes a coating 19 made from the polymer composition of the present disclosure.

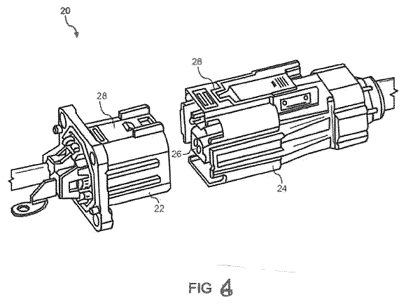

FIG. 3 illustrates a relay box 30 made in accordance with the present disclosure. The relay box 30 can include a metal substrate or conductive member 32. As shown, the metal substrate 32 has been overmolded with a polymer composition 34 in accordance with the present disclosure.

Referring to FIG. 4, a high voltage electrical connector generally 20 is shown. The connector 20 includes a first connector component 22 that is inserted into and interlocks with a second connector component 24. The electrical connector 20 can include an electrically conductive component 26 that is surrounded by a polymer component 28. The polymer component 28 can be made from the flame retardant polymer composition of the present disclosure. As shown in FIG. 4, the electrical connector 20 can have a complex shape with thin walls in certain areas. Due to the melt flow properties of the polymer composition of the present disclosure, the composition is well suited to forming the electrical connector 20 as shown in FIG. 4 through any suitable molding process, such as injection molding.

The present disclosure may be better understood with reference to the following example.

### EXAMPLE

Fiber-reinforced polymer compositions were formulated in accordance with the present disclosure and tested for various properties. In particular, the following compositions were formulated:

| | Sample | Sample |
|---|---|---|
| | No. 1 | No. 2 |
| Component | (wt. %) | (wt. %) |
| Polyamide 6,6 | 23.00 | 25.00 |
| Polyamide 6 | 16.25 | 16.25 |
| Fully vulcanized crosslinked thermoplastic | 3.0 | 5.0 |
| vulcanizate containing 52% by weight of an | | |
| ethylene/propylene/non-conjugated diene | | |
| copolymer rubber and an ethylene copolymer | | |
| Maleic anhydride | 0.5 | 0.5 |
| Glass fiber | 30 | 30 |
| Melamine polyphosphate | 4 | 4 |
| Masterbatch of 63.5% of aluminum | 18 | 18 |
| diethylphosphonate, 32% by weight melamine | | |
| polyphosphate, and 4.5% by weight zinc borate | | |
| Vegetable-based calcium stearate | 0.5 | 0.5 |
| Pentaerythritol tetrastearate | 0.2 | 0.2 |
| Benzene dicarboximide light stabilizer | 0.1 | 0.1 |
| Amorphous silica | 0.05 | 0.05 |
| Phosphite stabilizer | 0.2 | 0.2 |
| Hindered phenolic antioxidant | 0.2 | 0.2 |

The above compositions were tested for various mechanical properties, flame resistance, and for thermal shock cycles. The following results were obtained:

| | | Invention Samples | |
|---|---|---|---|
| | | Sample No. 1 | Sample No. 2 |
| Tensile Strength | MPa | 131 | 121 |
| Strain at Break | % | 2.24 | 2.21 |
| Notched Charpy, 23° C. | kJ/m² | 11.9 | 12.4 |
| Unnotched Charpy, 23° C. | kJ/m² | 61.9 | 56.6 |
| Flammability rating | 0.8 mm | V0 | V0 |
| Flammability rating | 1.5 mm | V0 | V0 |

Thermal shock cycles, −40° C. to 140° C.

| | | |
|---|---|---|
| Cycles @ 1^{st} crack | 504 | 504 |
| Cycles @ All crack | 648 | 696 |

As shown above, in addition to excellent mechanical properties, the polymer composition displayed excellent flame resistance and thermal shock resistance. Conventional glass fiber-reinforced polyamide compositions, for instance, typically display a thermal shock resistance of less than about 245 cycles. The polymer composition of the present disclosure doubled the thermal shock resistance in relation to many conventional products.

Sample No. 2 was also subjected to thermal shock resistance at a temperature of from −40° C. to 105° C. The composition did not experience a crack until after 1,368 cycles.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed is:

1. A polymer composition comprising:
one or more thermoplastic polymers present in an amount greater than about 20% by weight;
a flame retardant system comprising a metal phosphinate and a nitrogen-containing synergist, the flame retardant system being present in an amount greater than about 12% by weight;
reinforcing fibers being present in the polymer composition in an amount from about 5% by weight to about 50% by weight; and
a crosslinked thermoplastic vulcanizate comprising a crosslinked ethylene polymer and an at least partially cured elastomer.

2. A polymer composition as defined in claim 1, wherein the crosslinked ethylene polymer comprises an ethylene copolymer.

3. A polymer composition as defined in claim 2, wherein the ethylene copolymer comprises an ethylene and a C₃ to C₈ alpha-olefin.

4. A polymer composition as defined in claim 1, wherein the elastomer comprises an ethylene/propylene/non-conjugated diene copolymer rubber (EPDM).

5. A polymer composition as defined in claim 1, wherein the crosslinked thermoplastic vulcanizate comprises from about 10% by weight to about 90% by weight, of the at least partially cured elastomer and contains from about 10% by weight to about 90% by weight of the crosslinked ethylene polymer wherein the weight percent is based on the weight of the crosslinked thermoplastic vulcanizate.

6. A polymer composition as defined in claim 1, wherein the elastomer is fully vulcanized.

7. A polymer composition as defined in claim 1, wherein the crosslinked thermoplastic vulcanizate displays a Shore A hardness (ISO 868:2003) of from about 25 to about 100.

8. A polymer composition as defined in claim 1, wherein the thermoplastic polymer comprises at least one aliphatic polyamide.

9. A polymer composition as defined in claim 1, wherein the thermoplastic polymer comprises a polyamide 6, a polyamide 66, or mixtures thereof, one or more polyamides being present in the polymer composition in an amount from about 30% by weight to about 75% by weight.

10. A polymer composition as defined in claim 1, wherein the metal phosphinate comprises aluminum diethylphosphinate and is present in the polymer composition in an amount from about 6% by weight to about 18% by weight.

11. A polymer composition as defined in claim 1, wherein the nitrogen-containing synergist comprises a melamine or a melamine derivative.

12. A polymer composition as defined in claim 1, wherein the nitrogen-containing synergist comprises melamine polyphosphate.

13. A polymer composition as defined in claim 1, wherein the nitrogen-containing synergist is present in the polymer composition in an amount from about 3% by weight to about 14% by weight.

14. A polymer composition as defined in claim 1, wherein the polymer composition further contains an inorganic filler.

15. A polymer composition as defined in claim 14, wherein the inorganic filler comprises zinc borate.

16. A polymer composition as defined in claim 1, wherein the polymer composition further comprises a compatibilizer for the elastomer, comprising a maleic anhydride.

17. A polymer composition as defined in claim 1, wherein the crosslinked thermoplastic vulcanizate is present in the polymer composition in an amount from about 2% by weight to about 12% by weight.

18. A polymer composition as defined in claim 1, wherein the polymer composition displays a thermal shock resistance of greater than about 250 cycles.

19. A polymer composition as defined in claim 1, wherein the polymer composition displays a comparative tracking index of about 550 V or greater.

20. An overmolded article comprising a metallic substrate overmolded with the polymer composition as defined in claim 1.

21. An overmolded article as defined in claim 20, wherein the overmolded article comprises a busbar, an inverter, a converter, a charging base, a relay box housing, or a connector.
